(19) United States
(12) Patent Application Publication
(10) Pub. No.: US 2017/0342764 A1
(43) Pub. Date: Nov. 30, 2017

(54) DOOR SYSTEMS

(71) Applicant: John Charles Headrick, Alpharetta, GA (US)

(72) Inventor: John Charles Headrick, Alpharetta, GA (US)

(21) Appl. No.: 15/401,935

(22) Filed: Jan. 9, 2017

Related U.S. Application Data
(60) Provisional application No. 62/359,584, filed on Jul. 7, 2016.
(60) Provisional application No. 62/343,468, filed on May 31, 2016.
(60) Provisional application No. 62/371,587, filed on Aug. 5, 2016.

(51) Int. Cl. E06B 1/70; E06B 7/23

(52) U.S. Cl. CPC E06B 1/70; E06B 7/2316; E06B 2001/707

(57) ABSTRACT

A door sill has a substrate having a recessed upward open channel formed therein, an extruded aluminum deck that at least partially receives the substrate, at least one threshold cap, an interior face cap that covers a portion of the substrate, and a lock key. A first portion of the threshold cap is coupled to the extruded aluminum deck. A second portion of the threshold cap is positioned in the recessed upward open channel adjacent a portion of the interior face cap. A portion of the lock key is press fitted intermediate the second portion of the threshold cap and the portion of the interior face cap. A seal is formed between the second portion of the threshold cap and the interior face cap. The seal is positioned proximate the inside wall of the upward open channel formed in the substrate above the bottom surface of the upward open channel.

### CROSS-REFERENCE TO RELATED APPLICATIONS

This patent application claims priority to (1) U.S. Provisional Patent Application No. 62/359,584, entitled “Door Sills and Door Bottoms”, filed Jul. 7, 2016, (2) U.S. Provisional Patent Application No. 62/343,468, entitled “Door Bottom with Leak Preventing Exterior Edge Channel”, filed May 31, 2016, and (3) U.S. Provisional Patent Application No. 62/371,587, entitled “Double Door Sills and Shoot Bolt Sleeves”, filed Aug. 5, 2016, the entire disclosures of which are hereby incorporated by reference in their entirety.

### BACKGROUND

Sealing a closed entryway door unit system against the leakage of water has long been a problem for designers, manufacturers and installers of entry door units. The particular areas of the system that expose the leak problems are the lower corners of the door panel and the various components that come together in that complex corner. The complex corner at the interface of the door jamb, door sill, door bottom, door panel, weather-strips and optional corner pad is an impossibly difficult, complex corner to seal. The difficulty is compounded by the fact that sealing the corner and its odd fitting fixed and flexible components must not interfere with the door opening motions. Further, such complex corners are expected to function without wearing or shredding for some useful life. The present door bottoms and door sills discussed herein address the problems discussed above and additional problems associated with prior door sills and door bottoms.

### SUMMARY OF THE INVENTION

In various embodiments, a modular door sill comprises (1) a substrate having a recess formed therein, (2) an extruded aluminum deck comprising (a) at least one upward extending dam that comprises an inside protruding lip, (b) a first shoot bold guide, and (c) a second shoot bolt guide spaced apart from the first shoot bolt guide, (3) a rigid threshold cap comprising (a) an outside edge configured to be receive intermediate the at least one upward dam and the first shoot bolt guide, and (b) an inside edge configured to be received in the recess formed in the substrate, (4) an endcap having a first end that is at least partially received in the recess formed in the substrate, and (5) a lock key. In particular embodiments, the extruded aluminum deck at least partially covers a portion of the substrate. In certain embodiments, the interior face cap is received on the substrate such that the first end is at least partially received in the recess formed in the substrate. In some embodiments, the lock key is received intermediate the interior face cap first end and the rigid threshold cap second end to thereby lock the rigid threshold cap and the interior face cap in place.

In another embodiment, a door bottom comprises (1) a substantially flat carrier body that is configured to attach to the bottom edge of a bottom door rail, and (2) an upwardly open channel formed along the outside edge of the substantially flat carrier body, the channel comprising (a) a first channel appending wall that has a first end coupled to the substantially flat carrier body outside edge, (b) a channel bottom coupled to the second end of the channel appending wall, and (c) an upward extending second channel wall that is coupled to the channel bottom at a first end. In various embodiments, the length of the upwardly open channel is less than the length of the substantially flat carrier body. In some embodiments, when the door bottom is coupled to the bottom edge of the bottom door rail (1) the upwardly extending second channel wall second end is positioned adjacent an outside edge of the bottom edge of the bottom door rail, and (2) the air pressure in the upwardly open channel is substantially equal to the air pressure on the outside of the face of the door.

In still another embodiment, a door sill substrate comprises (1) an elongated body comprising (a) a top surface, (b) a bottom surface, (c) a first end, (d) a second end, (e) an inside edge extending between the first end and the second end, and (f) an outside edge extending between the first end and the second end, (2) an upward open channel formed through the elongated body top surface, the upward open channel comprising a bottom surface having a first portion and a second portion, and (3) a drainage channel having a first end that is positioned intermediate the bottom surface first portion and the bottom surface second portion and a second end that opens to the outside edge of the elongated body. In various embodiments, the first portion of the bottom surface is sloped downward toward the drainage channel.

In yet another embodiment, a door sill substrate comprises (1) an elongated body comprising (a) a top surface, (b) a bottom surface, (c) a first end, (d) a second end, (e) an inside edge extending between the first end and the second end, and (f) an outside edge extending between the first end and the second end, and (g) a plurality of groves formed on the bottom surface. In various embodiments, the plurality of grooves facilitates the spreading of caulking across the bottom surface so that the elongated body does not bow when installed.

In various embodiments, a door sill comprises (1) a substrate having a recessed upward open channel formed therein, (2) an extruded aluminum deck that at least partially receives the substrate, (3) at least one threshold cap, (4) an interior face cap that covers a portion of the substrate, and (5) a lock key. In various embodiments, a first portion of the at least one threshold cap is coupled to the extruded aluminum deck. In some embodiments, a second portion of the at least one threshold cap is positioned in the recessed upward open channel adjacent a portion of the interior face cap. In preferred embodiments, a portion of the lock key is press fitted intermediate the second portion of the at least one threshold cap and the portion of the interior face cap. In various embodiments, a seal is formed between the second portion of the at least one threshold cap and the interior face cap. In various embodiments, the seal is positioned proximate the inside wall of the upward open channel formed in the substrate above the bottom surface of the upward open channel.

### BRIEF DESCRIPTION OF THE DRAWINGS

Various embodiments of a system and method for creating and displaying a presentation are described below. In the course of this description, reference will be made to the accompanying drawings, which are not necessarily drawn to scale, and wherein:

FIG. 1 is a door system in accordance with an embodiment of the present system;

FIG. 2 is a partial perspective view of a door sill and door bottom in accordance with an embodiment of the present invention;

FIGS. 3-10 illustrate a method of assembling the door sill of FIG. 2;

FIGS. 11-12 illustrate a sidelight seat for use with the door sill of FIG. 2;

FIGS. 13-15 illustrate a method of attaching the sidelight seat of FIGS. 11-12 to the door sill of FIG. 2;

FIG. 16 is a perspective view of the door sill of FIG. 2 and the sidelight seat of FIG. 11-12 attached thereto and illustrates the modular nature of the door sill and sidelight seat;

FIG. 17A-17C are respectively a top plan view, a partial perspective view and a side view of a door bottom in accordance with one embodiment of the present invention;

FIG. 18 is a side view of the door bottom of FIG. 17C attached to a door and engaged with the door sill of FIG. 2;

FIG. 19 is a top perspective view of an embodiment of a molded substrate for use in the door sill of FIG. 2;

FIG. 20 is a bottom perspective view of the molded substrate of FIG. 19;

FIG. 21 is a partial perspective view of the molded substrate of FIG. 19;

FIG. 22 is a side view of the molded substrate of FIG. 19;

FIG. 23 is a partial top view of the molded substrate of FIG. 19;

FIG. 24 is a side view of an embodiment of an adjustable threshold cap for use in the door sill of FIG. 2;

FIG. 25 is a side view of the adjustable threshold cap in FIG. 2, with the threshold cap adjusted to a higher position than in FIG. 24;

FIG. 26A-26C are partial exploded views of the adjustable threshold of FIG. 24;

FIGS. 27-28 are side view of an embodiment of a door sill substrate and deck for use in the door sill of FIG. 2;

FIGS. 29A-29C illustrate a double door system in accordance with embodiments of the present invention;

FIGS. 30A-30C illustrate an embodiment of a door sill for use in the double door system of FIGS. 29A-29C;

FIGS. 31A-31C illustrate the door sill of FIGS. 30A-30C;

FIGS. 32A-32B illustrate the operation of the double door system of FIGS. 29A-29C using the door sill of FIGS. 30A-30C;

FIGS. 33A-33C is a partial perspective view of the double door system and door sill of 29A-30C;

FIGS. 34A-34B are respectively a side view and a partial perspective view of a prior art Endura articulating threshold door bottom including the door bottom improvements described in FIGS. 17A-18;

FIGS. 35A-35B are respectively a side view and a partial perspective view of a prior art Endura articulating threshold door bottom including the channel improvements described in FIGS. 17A-18;

FIGS. 36A-36B are respectively a side view and a partial perspective view of a prior art HVC 4000 door bottom including the channel improvements described in FIGS. 17A-18; and

FIGS. 37A-37B are respectively a side view and a partial perspective view of a prior art ThermaTru door bottom including the channel improvements described in FIGS. 17A-18.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Like numbers refer to like elements throughout.

### Overview

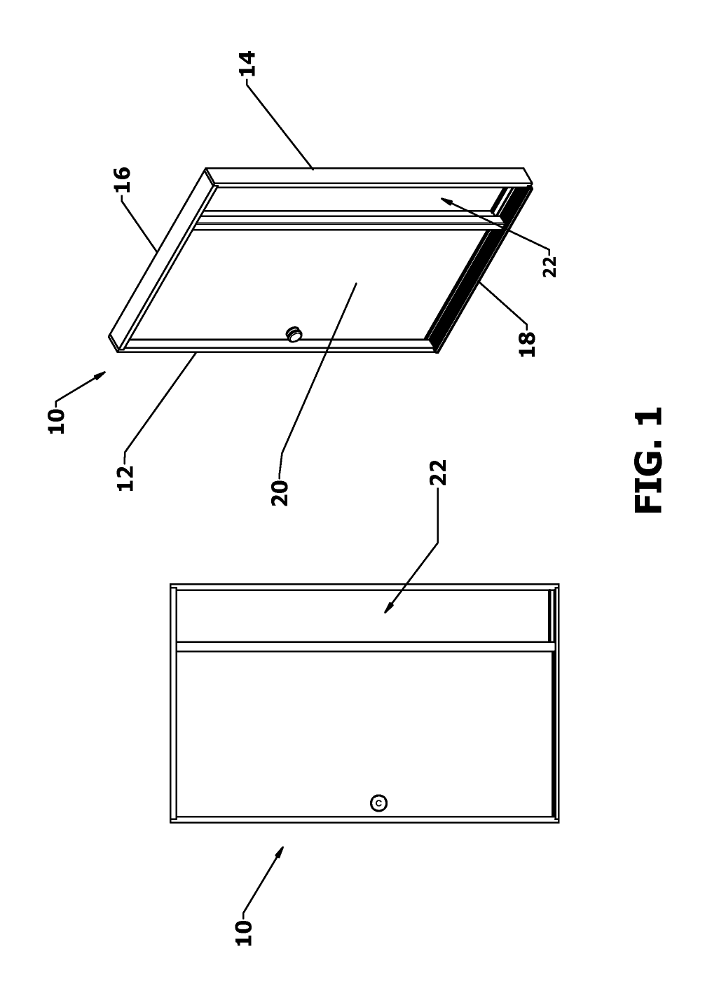

Referring to FIG. 1, the invention is generally related to doors and, in particular, to a new and improved fixed modular door sill and door bottom. A door unit 10 typically comprises a left jamb 12, a right jamb 14, a header 16 that connects to left jamb 12 and the right jamb 14 and a door sill 18 that couples the bottom of the left jamb 12 and right jamb 14. A door panel 20 is pivotally mounted to one of the left door jamb 12 or right door jamb 14 depending on whether the door is a right hand open or left hand open door. In some embodiments, the door unit 10 further comprises an opening 22 for a sidelight panel. For purposes of this disclosure, reference to “inside” refers to a direction that is toward the inside of the structure to which the door sill and door bottom are to be installed, and reference to “outside” refers to a direction that is toward the outside of the structure to which the door sill and door bottom are to be installed. Thus, for example, an outside extending protrusion is one that extends from a surface toward the outside of the structure when the door sill and/or door bottom has been installed in the structure. Moreover, an inside open recess is a recess that opens toward the inside of the structure. As another example, an outside edge of a structure is the edge of the structure that is closest to the outside of the structure.

### Door Sill

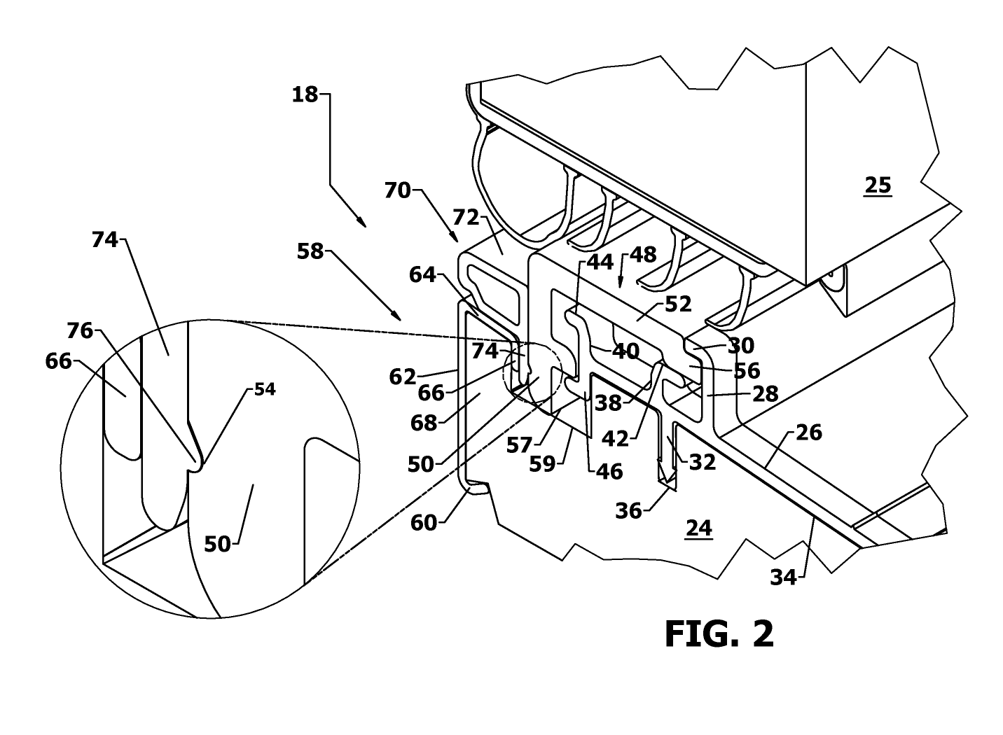

Referring to FIG. 2, the door sill 18 comprises a composite substrate 24, and an extruded aluminum deck 26 that is configured to mount over a portion of the substrate 24. The extruded aluminum deck further comprises a raised dam 28 that ends in an inside protruding lip 30. An engagement barb 32 extends from a bottom surface 34 of the extruded aluminum deck 26 and is configured to be received in a slot 36 formed in a top surface of the substrate 24. A first raised shoot bolt guide 38 and a second raised shoot bolt guide 40 extend upward from a top surface of the extruded aluminum deck 26. The first raised shoot bolt guide 38 terminates in an outside projecting support flat 42 and the second raised shoot bolt guide 40 terminates in a second inside projecting protruding mull post/threshold support flat 44. A second sill positioning strengthening flange 46 extends from the bottom surface of the extruded aluminum deck 26 and may, in some embodiments be integrally formed with the second raised shoot bolt guide 40.

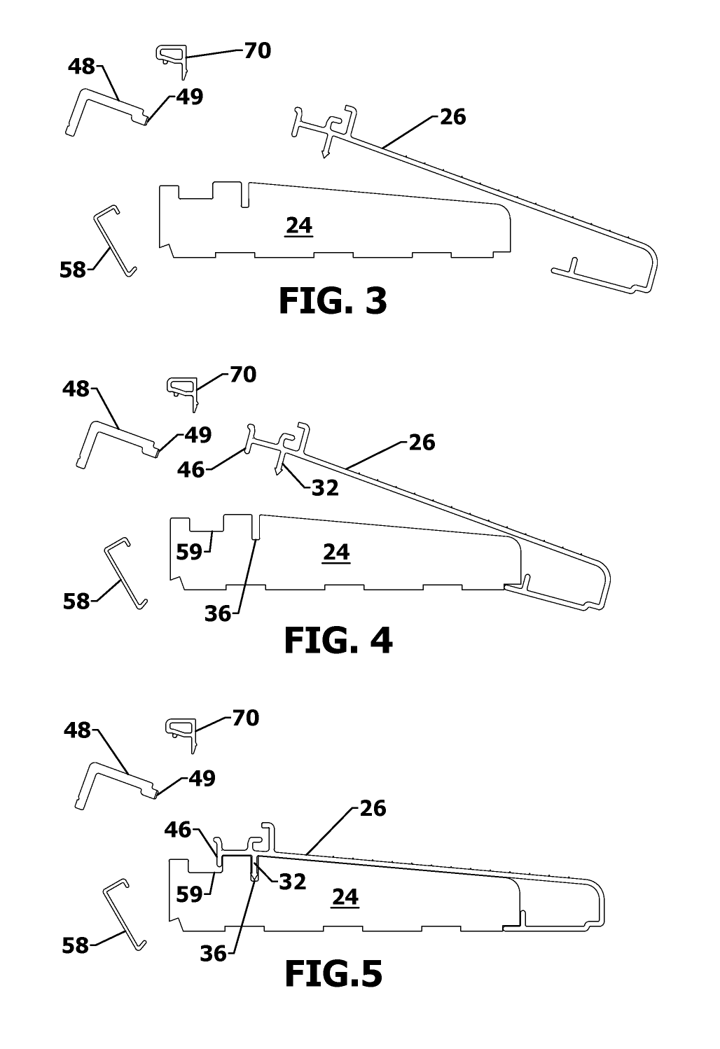

Still referring to FIG. 2, an L-shaped rigid threshold cap 48 comprises a first vertical leg 50 and a second horizontal leg 52. The first vertical leg 50 contains a recess 54 formed proximate a free end (inside edge) of the first vertical leg 50. The second horizontal leg 52 terminates in a recessed lip 56 (the outside edge). The recessed lip 56 is configured to fit between the inside protruding lip 30 and the flat 42 on the first shoot bolt guide 38. The end 57 of the vertical leg 50 is sized so that it rests in a recess 59 of the substrate 24. In various embodiments, the end of the recessed lip may contain a flexible, semi flexible or rigid sealing member 49 (FIGS. 3-10) that forms a seal between the L-shaped rigid threshold and the upward extending vertical dam 28. rigid generally C-shaped cap (e.g., an interior face cap or shoe face) 58 comprises a curved first end 60, an elongated vertical middle portion 62 and a horizontal top portion 64. The horizontal top portion terminates in a downward extending vertical lip 66. The C-shaped interior face cap 58 is configured to be received on an inside end 68 of the substrate 24. Finally, a lock mechanism 70 is received intermediate the vertical leg 50 of the L-shaped rigid threshold cap 48 and the vertical lip 66 of the C-shaped cap 58. The lock mechanism 70 comprises a generally circular cross-section first portion 72 and a vertical tab portion 74. The vertical tab portion 74 further comprises a ridge 76 that runs the length of the vertical tab portion 74 that is configured to be received in the recess 54 so as to retain the lock mechanism 70 in place and to create a seal between the air pressure inside the structure and the air pressure outside the structure to which the door sill and door bottom is mounted.

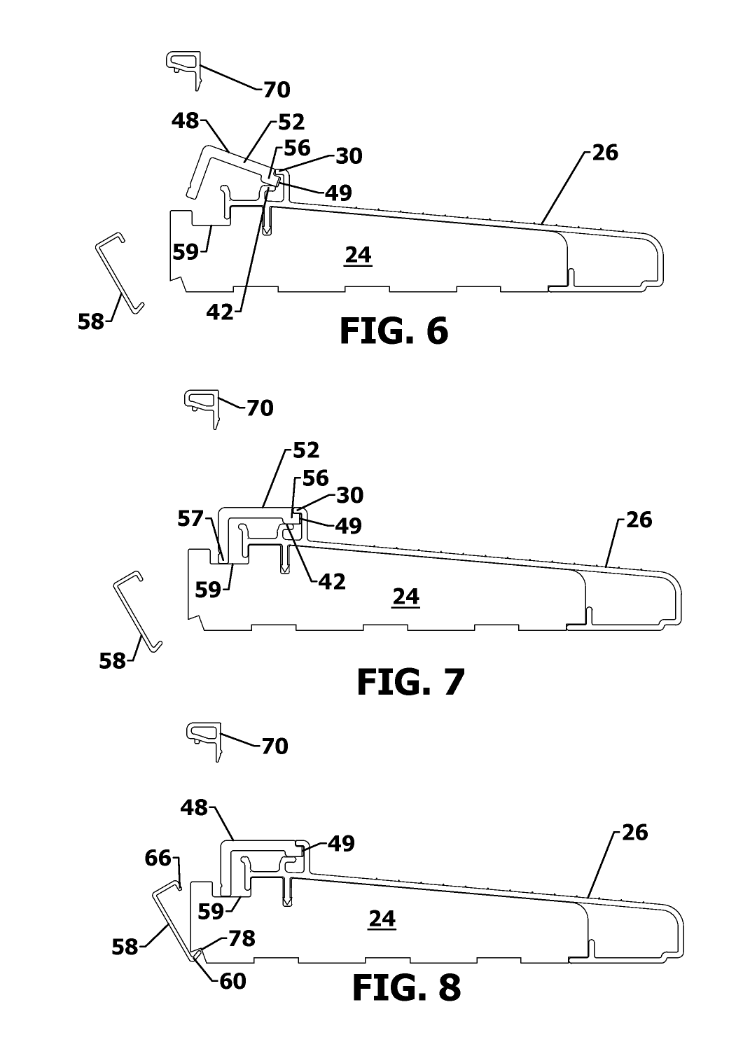

Referring to FIGS. 3-5, the fixed door sill is put together by first coupling the extruded aluminum deck 26 over a portion of the substrate 24 so that the engagement barb 32 is received in the slot 36 formed in the substrate 24 and the strengthening flange 46 is received in the recess 59. Next and referring to FIGS. 6 and 7, the L-shaped rigid threshold cap 48 is coupled to the extruded aluminum deck 26 by placing the recessed lip 56 of the horizontal leg 52 intermediate the dam inside protruding lip 30 and the flat outside protruding lip 42 on the top of the first shoot bolt guide that rises from the aluminum deck 26. Once in this position, the L-shaped rigid threshold cap 48 is rotated about the recessed lip 56 until the end 57 (FIG. 2) of the vertical leg 50 of the L-shaped rigid threshold cap 48 rests against the surface of the substrate 24 in the recess 59.

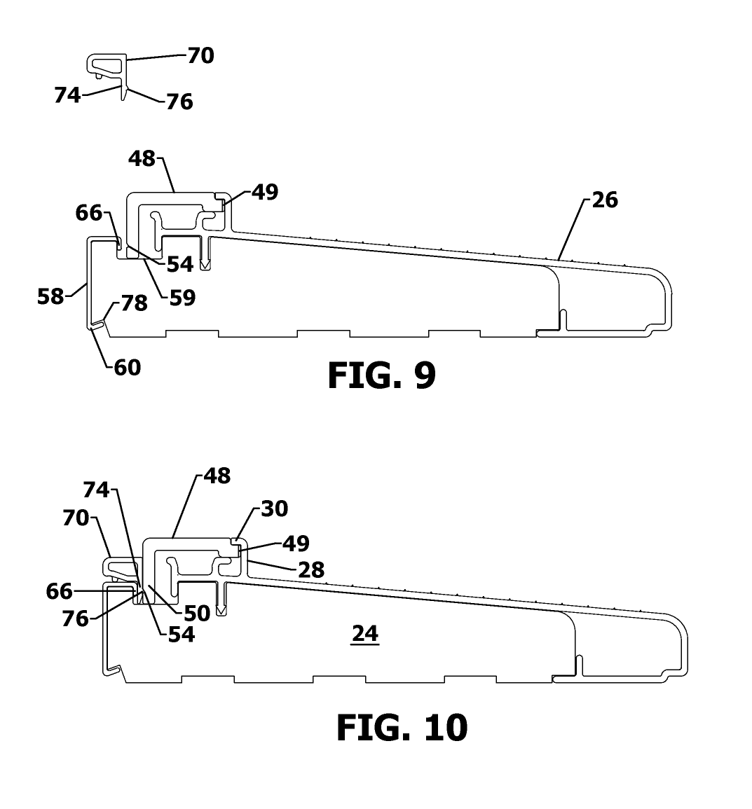

Once the L-shaped rigid threshold cap 48 is in place, the C-shaped interior face cap 58 is placed on the rear of the substrate 24 by sliding the end of the substrate 24 into the C-shaped cap so that the curved first end 60 is received in a recess 78 formed in a bottom of the substrate 24 (FIG. 8) and the vertical lip 66 is received in the recess 59 formed in the top of the substrate, as shown in FIG. 9. In other embodiments, the C-shaped cap 58 can be snapped onto the rear of the substrate 24 by placing the curved first end 60 into the recess 78 and pressing the vertical lip 66 into the recess 59. Finally and referring to FIG. 10, the lock mechanism 70 vertical portion is pushed intermediate the vertical lip 66 of the C-shaped cap 58 and the vertical leg 50 of the L-shaped rigid threshold cap until the ridge 76 is received in the recess 54.

Referring to FIG. 10, the raised dam 28 and inside protruding lip 30 provides protection to the rigid threshold cap of the threshold since this is typically the first part of the sill that is struck and damaged by objects being pulled across the sill. Thus, while the extruded aluminum deck 26 is typically formed from aluminum or any other suitable metal or alloy or suitable rigid polymer, the remaining portions of the sill may be formed from any suitable material such as metals, alloys, ceramic, polymers, etc. Additionally, because the lock mechanism 70 vertical portion is inserted intermediate the vertical leg 50 of the L-shaped rigid threshold cap 48 until the ridge 76 is received in the recess 54, a seal is created between the ridge 76 and recess 54 thereby helping preventing air pressure equalization between the air pressure inside the structure and air pressure outside the structure to which the door sill is installed.

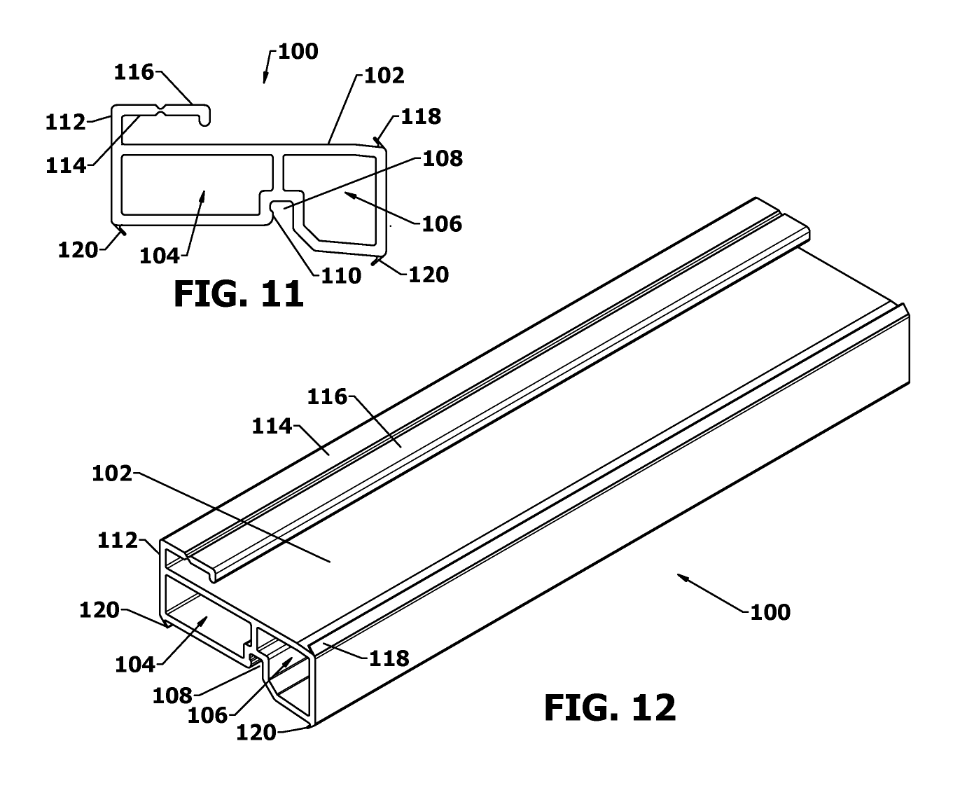

Referring to FIGS. 11 and 12, a seat 100 for a sidelight panel is shown. The seat 100 may be formed from a polymer, a ceramic, or composite wood material, a composite cement material or any other suitable material that allows the seat to flex. In a preferred embodiment, the sidelight (or fixed door panel) seat 100 is formed from a rigid polymer structure. The seat 100 comprises a generally rectangular shaped body 102 that contains two joined box channels 104 and 106 that run the length of the body 102. A lock channel 108 runs the length of the seat 100 and contains an outside protruding protruding lip 110. The sidelight seat 100 further comprises a vertical post 112 and an outside protruding lip 114 that contains a tear off strip 116. A flexible fin 118 is positioned to form a seal against the bottom of the sidelight panel when the sidelight panel is positioned on the seat 100. The seat 100 also contains two lower flexible fins 120 that are used to form a seal when the seat is coupled to the sill, as described in greater detail below.

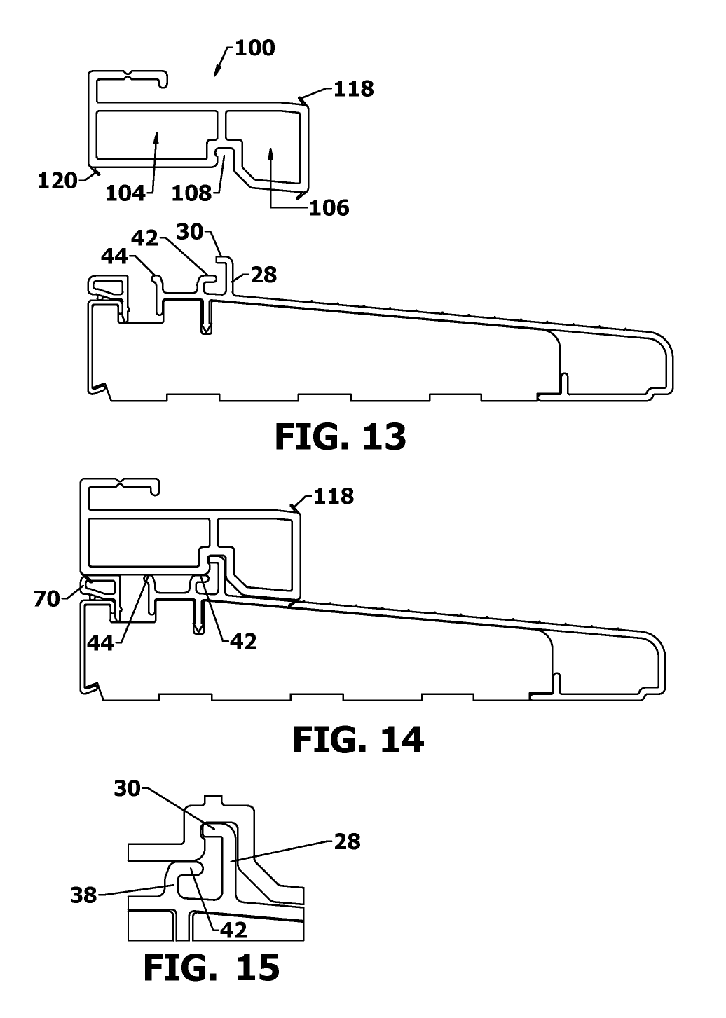

Referring to FIGS. 13-14, the sidelight seat can be coupled to the extruded aluminum deck 26 along any portion of the length of the deck 26 by coupling the channel 108 to the raised dam 28 and inside protruding lip 30, as shown in FIG. 14.

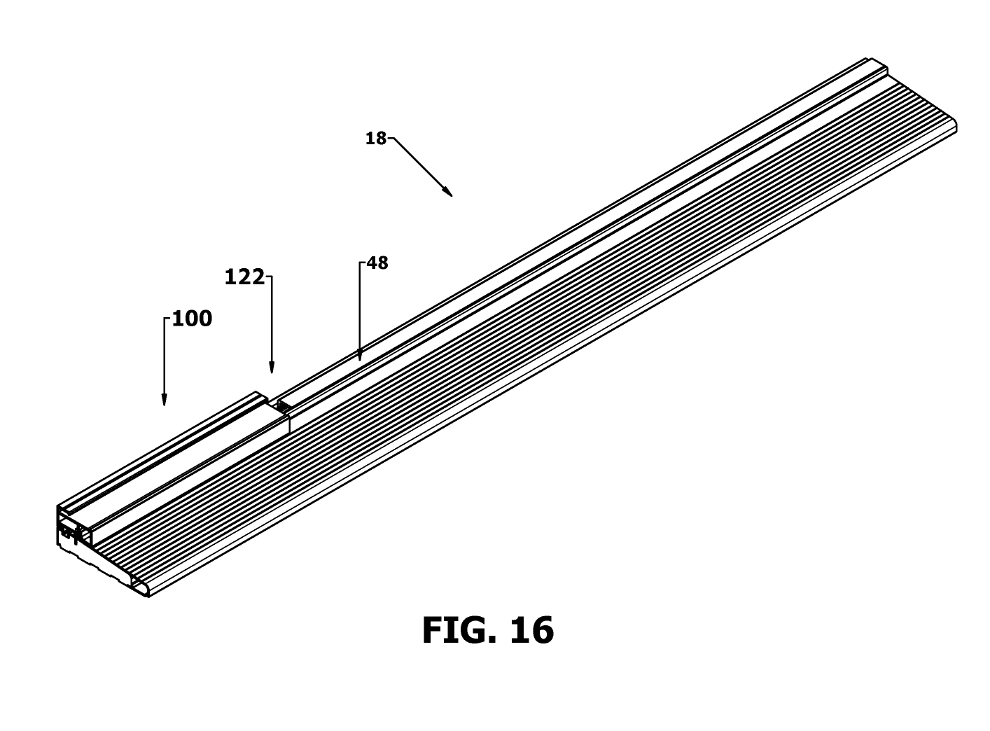

Referring to FIG. 15, when the sidelight seat 100 is inserted into the channel 108, the outside protruding lip 110 of the seat 100 is positioned intermediate the inside protruding lip 30 and the outside protruding flat 42 of the first shoot bolt guide 38. In this way, the seat is supported by the flats 42 and 44 of the respective first and second shoot bolt guides 38 and 40 and the lock mechanism 70 (FIG. 14).

Referring to FIG. 16, the sill 18 is shown having a seat 100 for a sidelight panel mounted to the left side of the sill from the outside looking in. The threshold cap 48 may be cut to size and allow for a gap 122 where the mull post fits between the sidelight seat 100 and the threshold cap 48. It should be understood that under the current design, the user does not need to trim any sill components to allow for any of the jambs and mull post to be placed. Thus, the sidelight seat and sill are modular and allow the sidelight seat to be moved from the left side of the sill to the right side or to include a sidelight seat 100 on both sides of the door frame. All of this can be accomplished since the rigid threshold cap 48 and sidelight seat 100 are removable/replaceable prior to door unit assembly to avoid having the door shop maintain left and right sidelight continuous door sills. Additionally, the lock mechanism 30 and the rigid threshold cap 48 are replaceable after the door unit has been installed on the job site.

### Door Bottom

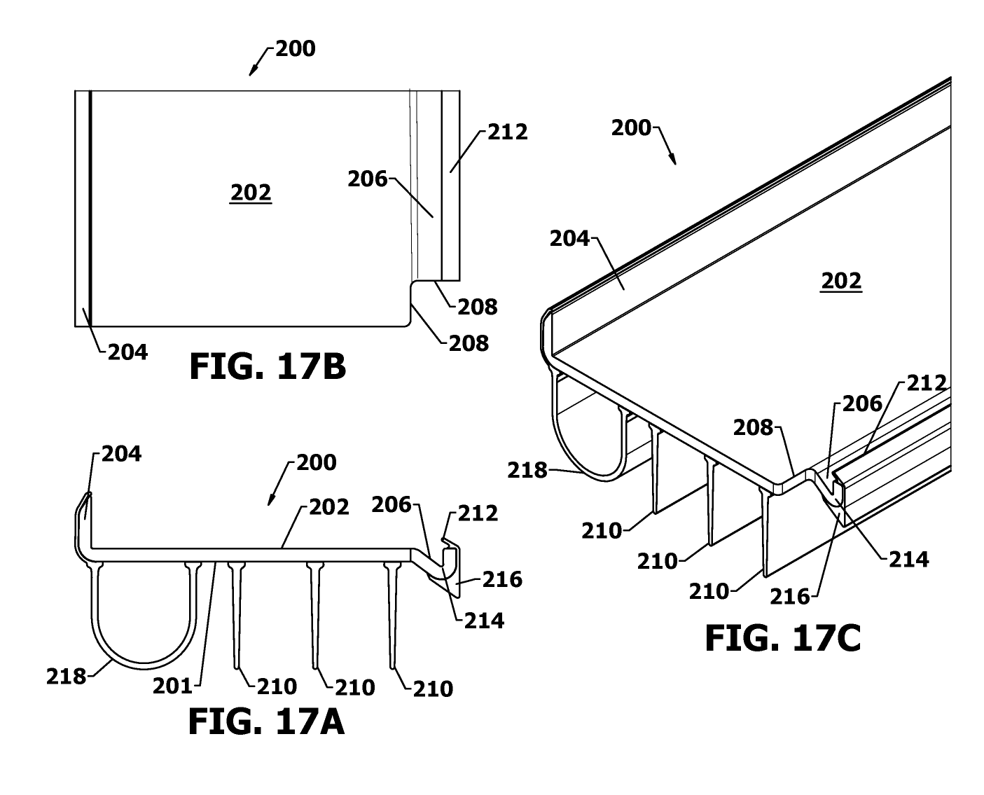

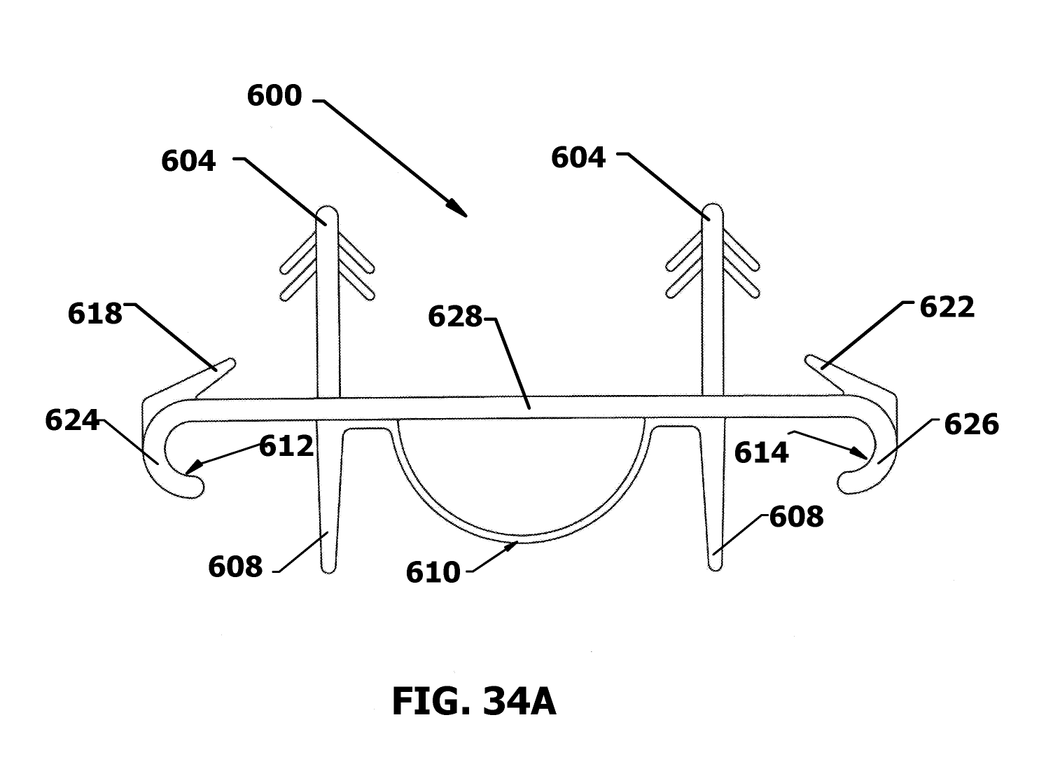

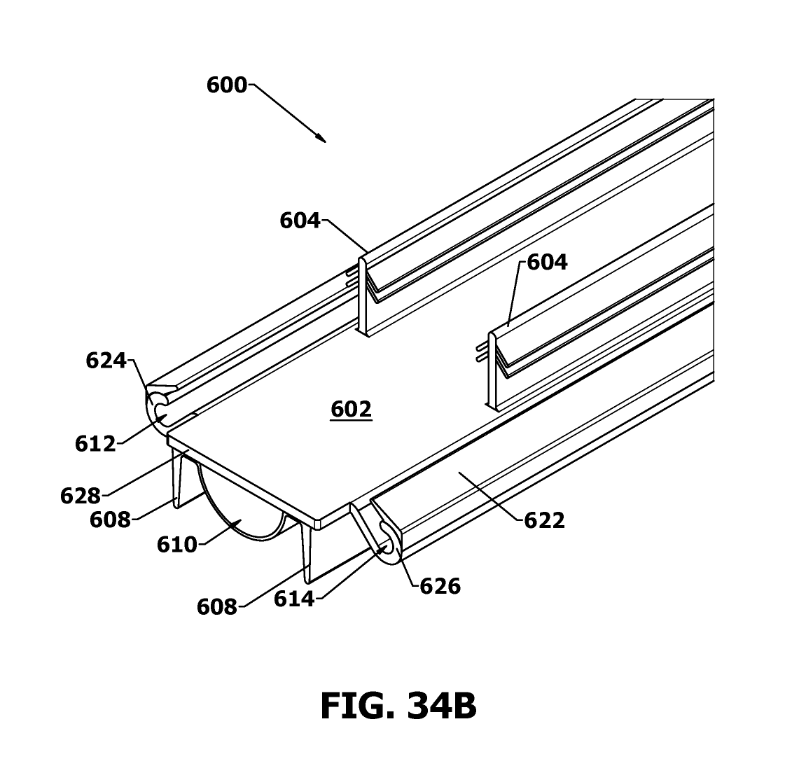

Referring now to FIGS. 17A-17C, one embodiment of the door bottom 200 is shown formed from a generally flat carrier 202 having a vertical arm 204 for lateral alignment of the door bottom for correct location of the door bottom during door unit assembly formed on the interior and a channel 206 formed at the exterior side. A notch or slant cut 208 is formed at an end of the channel 206 on one or both ends of the channel. The carrier 202 may be formed from any suitable rigid material such as polymers, rubber, metal, alloy, ceramic, etc. The door bottom 200 also contains one or more downward extending flexible sealing fins 210. Additionally, a flexible sealing fin 212 is formed on an upward leg 214 that defines the exterior side of the channel 206. A drip flow guide 216 may be formed around the lower edge of the upward leg 214, which may be flexible or rigid. Finally, one or more flexible sealing bulbs 218 may be formed on the bottom surface 201 of the carrier 202. In various embodiments, the flexible fins 210 and the flexible sealing bulb 218 may be integrally formed with the flat body 202. In other preferred embodiments, the flexible fins 210 and the flexible sealing bulb may be formed separately from the flat body 202 and attached to the bottom 201 of the flat body 22 using adhesive, friction stir welding, or any other suitable means of attachment. It should be understood that a channel 206 may be formed on one or both of the interior side or the exterior side generally flat carrier 202, as shown in one or more of the various embodiments of the door bottom of FIGS. 34A-37B, as discussed in more detail below.

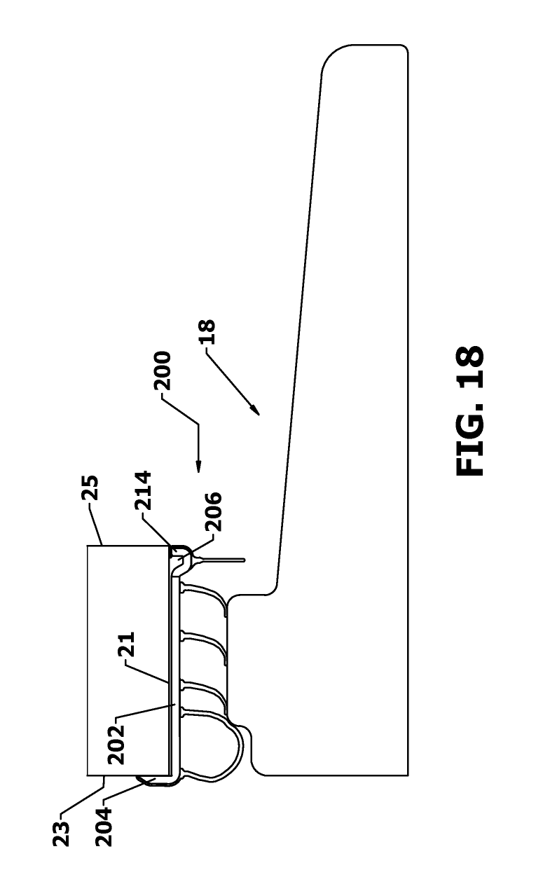

Referring to FIG. 18, the door panel 20 of FIG. 1 is shown having the door bottom 200 of FIGS. 17A-17C attached thereto. It should be understood that the door bottom 200 may be attached to a bottom surface 21 of the bottom rail of the door panel 20 by staples, vertical attachment barbs (shown in FIGS. 34A-37B) formed on a top surface of the flat carrier 202 that are received in groves formed in the bottom surface 21 of the bottom rail of the door 20, or by any other attachment means. When the carrier 202 is attached to the door panel 20, the top surface of the carrier 202 generally abuts the bottom rail 21 of the door. The vertical arm 204 wraps around an inside surface 23 of the door panel 20, which faces the inside of the structure. The channel 206 is positioned adjacent to the bottom rail 21 so that the outside wall of the channel is in the same plane as the outside surface 25 of the door 20 so that the upward lip 214 and sealing fin 212 abuts the bottom rail 21 of the door. In other embodiments such as those shown in 34A-35B, portions of the channel 206 may extend past the plane of the outside surface 25 of the door 20 (FIG. 18).

In prior art doors, the air pressure outside the door is typically higher than the air pressure inside the structure to which the door is attached when the wind is blowing against the outside surface of the door. Typically, as rain hits the door and runs down the outside face 25 of the door down to the edge of the door bottom, the pressure differential between the inside of the structure and the outside of the structure causes the water to be drawn between the carrier 202 and the bottom rail lower face 21 causing the water to pool or flow to the inside. The pooling water can cause a wooden door rail to rot or the flowing water can leak through to the inside of the structure.

The presence of the channel 206 along the length of the door panel 20 adjacent the outside surface of the door 25 allows air to enter the channel from one or more notches or slants 208. Said another way, because the channel 206 adjacent the outside surface 25 of the door panel 20 is allowed to equalize in pressure to the outside pressure, the drawing (e.g., sucking) action from outside to inside due to the pressure differential between the outside of the structure and the inside of the structure is disrupted thereby preventing water from being drawn between the top surface of the carrier 202 and the door rail bottom face 21. Instead, the water cascades down the front surface 25 of the door panel over the upper lip 214 and drips down onto the decking in front of the dam 28. It should also be understood that the location of the channel 206 may be positioned more toward the interior edge of the carrier 202. However, in preferred embodiments, the position of the channel 206 should be at least outward of the dam 28 so that the water is not drawn inward of the threshold cap 48.

### Substrate

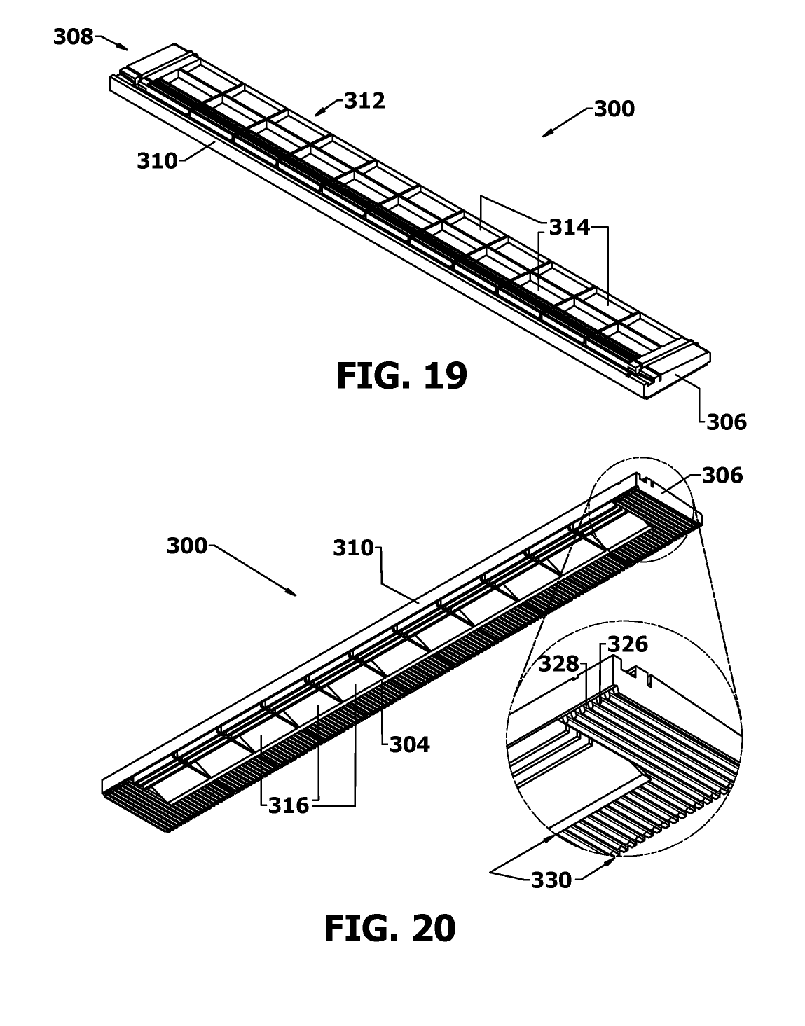

Referring to FIGS. 19 and 20, a molded substrate 300 is shown comprising a top surface 302, a bottom surface 304, a first end 306, a second end 308 and an inside surface 310 and an outside face that extend between the first end 306 and the second end 308. The top surface 302 is formed with a plurality of recessed areas 314. Additionally, the bottom surface also comprises a plurality of recessed areas 316. In various embodiments, the recesses are bounded by ridges between the recessed areas that provide strength and rigidity to the overall substrate structure 300. The molded substrate may be formed from any suitable method such as extruding, injection molding, etc. Moreover, the substrate may be formed from any suitable material (e.g., polymer, composite, etc.).

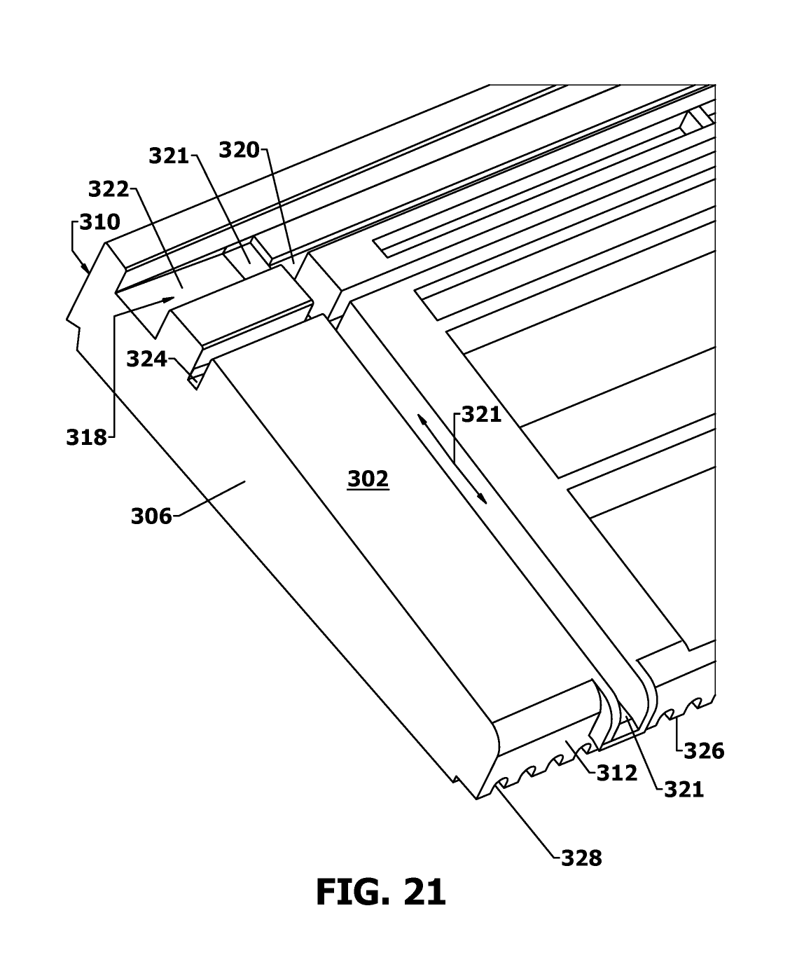

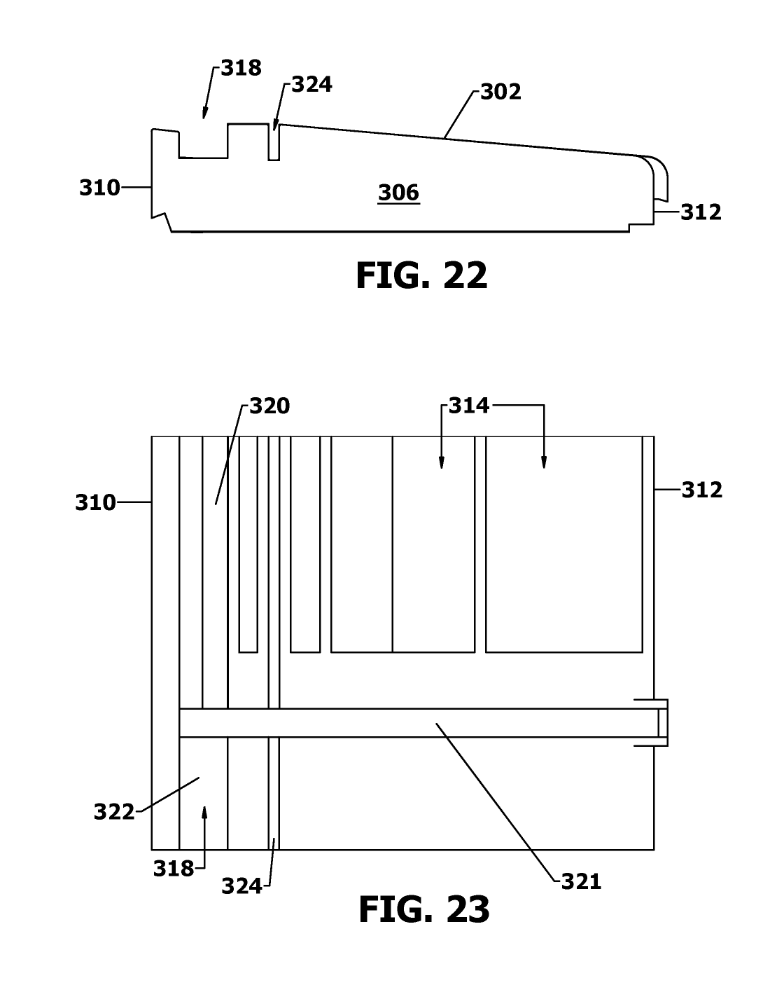

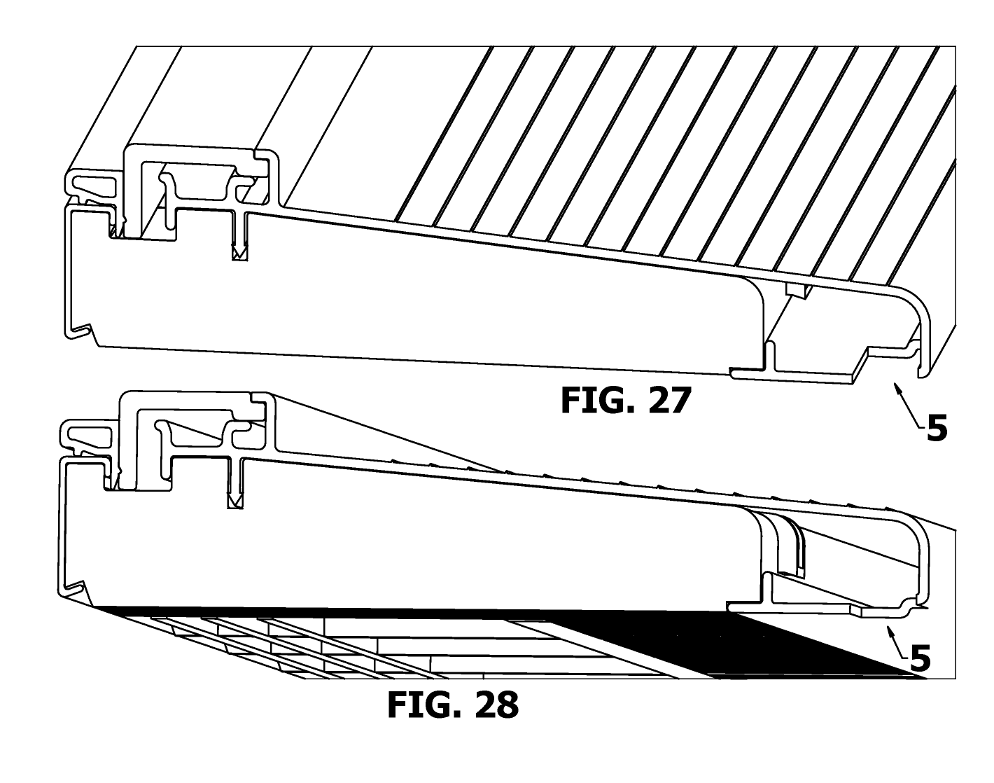

Referring particularly to FIGS. 21-23, the substrate 300 contains an upward open channel 318 that has a bottom surface 320. A portion 322 of the bottom surface 320 is sloped downward away from the first end 306 toward a drainage channel 321. The drainage channel 321 extends from the upward open channel 318 out through the outside surface 312. Thus, any leakage of water that gets on a threshold cap that covers the upward open channel flows down the sloped portion 322 of the channel bottom 320 and directs water toward the drainage channel 321. Referring quickly to FIGS. 27 and 28, the deck that covers the substrate may contain a through hole or notch 5 that allows water that collects and empties through the drainage channel 321 to pass through the deck. The through hole or notch 5 is positioned on the bottom outside edge of the deck so as to prevent an installer from plugging the opening when the door is installed. Moreover, the drainage channel 321 forms a basin adjacent the channel bottom 320 to prevent any accumulation of water on the channel bottom 320.

The substrate 300 also contains a deck receiving slot 324 that extends from the first end 306 to the second end 308. The deck receiving slot 324, in various embodiments, may also contain a slanted bottom floor that slopes toward the drainage channel 321 similar to the portion 322 of the bottom surface 320. The deck receiving slot 324 is configured to receive a portion of the deck (e.g., barb 32 FIG. 2) to help secure the deck to the substrate. It should be understood that the slot 324 may be a continuous slot that extends from the first end 306 to the second end 308. In other embodiments, the slot 324 may be intermittently formed across the top surface.

The bottom surface of the substrate 304 (FIGS. 19 & 20) contains one or more ridges 326 and corresponding grooves 328 that extend between a portion of the bottom surface 304 between the outside edge 312 and the inside edge 310. In various embodiments and referring to FIG. 20, some of the ridges 326 and groves 328 are formed across a front half 330 (FIG. 20) of the bottom surface 304 such that the grooves extend outward from the recessed areas 316 to the outside edge 312 and other groves and recess extend from the inside edge 310 to the outside edge 312.

In various embodiments, the inside to outside aligned grooves allow for caulk that is used to secure and seal the sill to the floor to evenly spread out when the sill is installed. That is, because the caulking can spread into the inside to outside aligned grooves, the caulking is prevented from flowing from the ends toward the middle causing the center of the sill to bow upward. Thus, the user can place of bead of caulking across the opening where the door is being installed and the sill can be inserted into the opening over the caulking. As the sill is pressed downward onto the floor and over the caulking, the caulking spreads and fills the grooves 328. As stated above, the spreading of the caulking eliminates or at the very least substantially reduces any upward bowing that may occur with flat bottomed substrates.

### Adjustable Threshold Cap

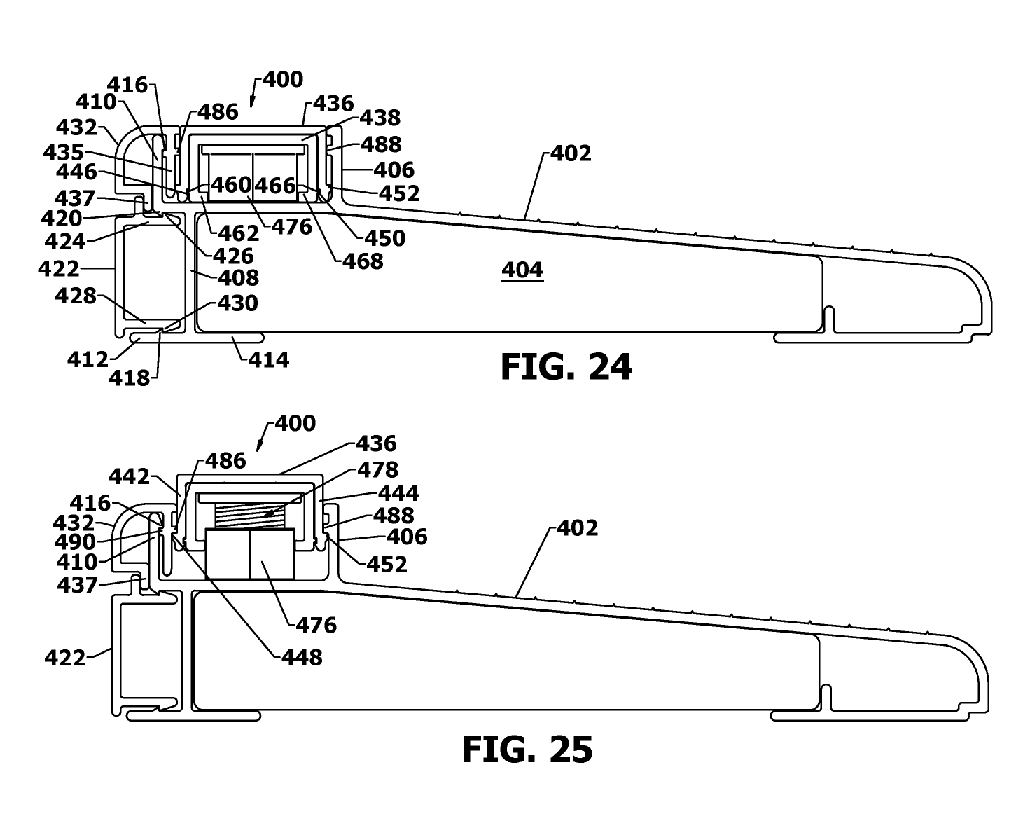

Referring to FIGS. 24-26, an adjustable threshold cap 400 is shown installed on a extruded aluminum deck 402 that is received on a substrate 404. The extruded aluminum deck 402 contains an outside dam 406, an upwardly extending inside end face 410 and a downwardly extending I-beam 408 that terminates at a bottom inside extending flange 412 and outside extending flange 414. The upwardly extending inside face 410 contains a first outward extending protrusion 416. Additionally, the inside extending flange 412 contains an upwardly extending second protrusion 418. The upwardly extending inside face 410 also contains a third downwardly extending protrusion 420.

A C-shaped cap 422 is received on the inside edge of the extruded aluminum deck 402 intermediate the upwardly extending inside face 410 and the inside extending flange 412. The C-shaped cap 422 contains a first leg 424 having a first upwardly extending protrusion 426 formed at an end thereof and a second leg 428 having a second downwardly extending protrusion 430 formed at and end thereof. The first leg first upwardly extending protrusion 426 interacts with the first downwardly extending protrusion 420 and the second leg second downwardly extending protrusion 430 interacts with the upwardly extending second protrusion 418 to lock the C-shaped cap 422 to the extruded aluminum deck 402. The C-shaped cap 422 may be formed from any suitable material such a polymer, a metal, etc.

Referring to FIG. 25, a lock key 432 comprises a first end 435 that is received intermediate the upwardly extending inside face 410 of the deck 402 and the adjustable threshold cap 400 and a second end 437 that is received intermediate the C-shaped cap 422 and the upwardly extending inside face 410. The lock key 432 locks the adjustable threshold cap 400 in place and also provides an aesthetically pleasing finish to the inside edge of the door sill. The lock key 432 may be formed from any suitable material such as a polymer, a metal, etc.

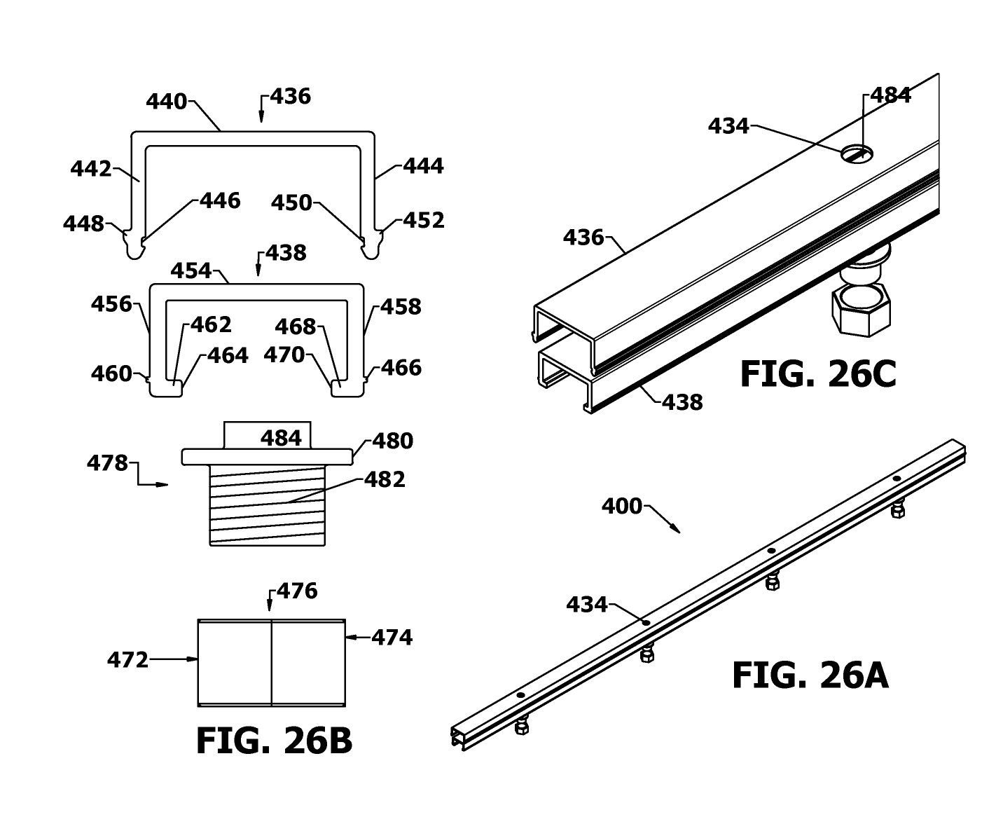

Referring to FIGS. 26A-26C, the adjustable threshold cap 400 is shown having a plurality of circular openings 434 along the length of the threshold cap 400. The adjustable threshold cap 400 is formed from an outer covering 436 and an inner body 438. The outer covering 436 is formed from a substantially horizontal body 440 and a first downward extending leg 442 and a second downward extending leg 444. The first downward extending leg 442 contains a first outside open recess 446 and a first inside extending protrusion 448. Additionally, the second downwardly extending leg 444 contains a second inside open recess 450 and a second outside extending protrusion 452. It should be understood that the outer covering 436 may be formed where the horizontal body 440 and first and second downward extending legs 442 and 444 are integrally formed with one another, and in other embodiments the parts may be separately formed and coupled to one another by any suitable means. In various embodiments the outer covering 436 may be formed from any suitable material such as polymers, metals, etc. In preferred embodiments, the outer covering is formed from a polymer and the inner body is formed from a metal.

The inner body 438 is formed from a substantially flat body 454 having a first downwardly extending leg 456 and a second downwardly extending leg 458. The first downwardly extending leg 456 contains a first inside extending protrusion 460 and a first outside extending flange 462 that terminates in a first end 464. Additionally, the second downwardly extending leg 458 contains a second outside extending protrusion 466 and a second inside extending flange 468 that terminates in a second end 470. The first and second ends 464 and 470 of the first and second flanges 462 and 468 are spaced apart a sufficient distance to so that the first and second flange ends 464 and 470 respectively receive a first and second flat 472 and 474 on the outside surface of a fastener (e.g., a hex bolt) 476. Said another way, when the fastener 476 is inserted between the first and second ends 464 and 470 of the first and second flanges 462 and 468, the flanges prevent the fastener 476 from rotating. Thus, when a screw 478 comprising a radially extending flange 480, threads 482 on an outer surface and a generally circular shaped head 484 is threaded in the fastener 476 such that the circular shaped head extends through a respective hole 434, a user can adjust the height of the threshold cap 400 by rotating the screw 478 with respect to the fastener 476, which is held stationary by the first and second ends 464 and 470 of the first and second flanges 462 and 468.

Referring once more to FIG. 24, the inner body 438 is inserted into the outer cover 436 so that the first outside opening recess 446 formed in the first leg 442 of the outer cover 436 receives the first inside extending protrusion 460 formed on the first leg 456 of the inner body 438. Likewise, the first inside opening recess 450 formed in the second leg 458 of the outer cover 436 receives the second outside extending protrusion 466 formed on the second leg 458 of the inner body 438. This configuration locks the outer cover 436 to the inner body 438 to create a unitary threshold cap 400. In various embodiments, the outer cover 436 and the inner body 438 may be formed in one integral piece.

Still referring to FIG. 24, the threshold cap 400 is inserted intermediate the upward extending dam 406 and the upwardly extending inside face 410 of the deck 402 such that the first inside extending protrusion 448 (FIG. 25) on the first leg 442 of the outer cover 436 engages with an outside extending protrusion 486 formed on a portion of the key lock 432. Additionally, an inside extending protrusion 490 formed on the key lock 432 also engages with the outside extending protrusion 416 formed on the upwardly extending inside face 410. Finally, the outside extending protrusion 452 formed on the second leg 444 of the outer cover 436 engages with an inside protruding protrusion 488 of the upward extending dam 406.

Still referring to FIG. 25, the threshold cap 400 is shown in an extended position where the user rotates the screw 478 with respect to the fastener 476 so that the screw moves upward with respect to the fastener. As the screw moves upward, the threshold cap 400 moves upward with respect to the deck 402. The threshold cap 400 can move a predetermined distance until the inside extending first protrusion 448 and the outside extending second protrusion 452 respectively engages with the outside extending protrusion 486 on the key lock 432 and the inside extending protrusion 488 on the upwardly extending dam 406, which act as stops to prevent the threshold cap 400 from moving upward.

### French Door System and Door Sill

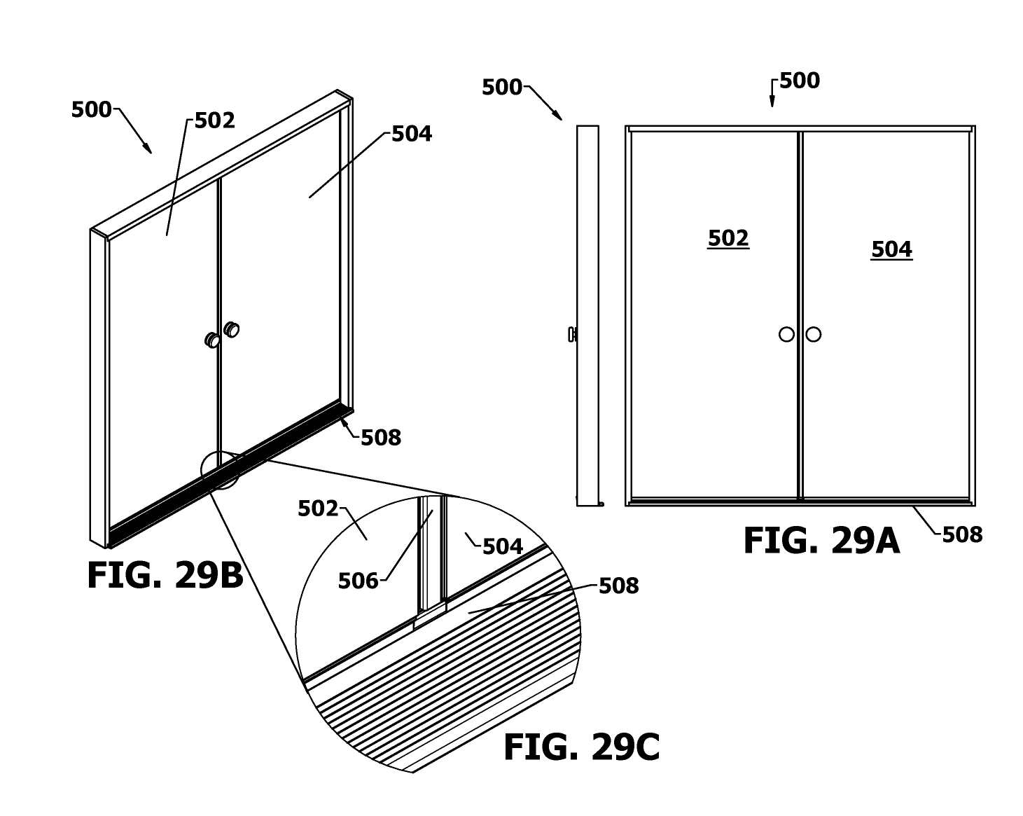

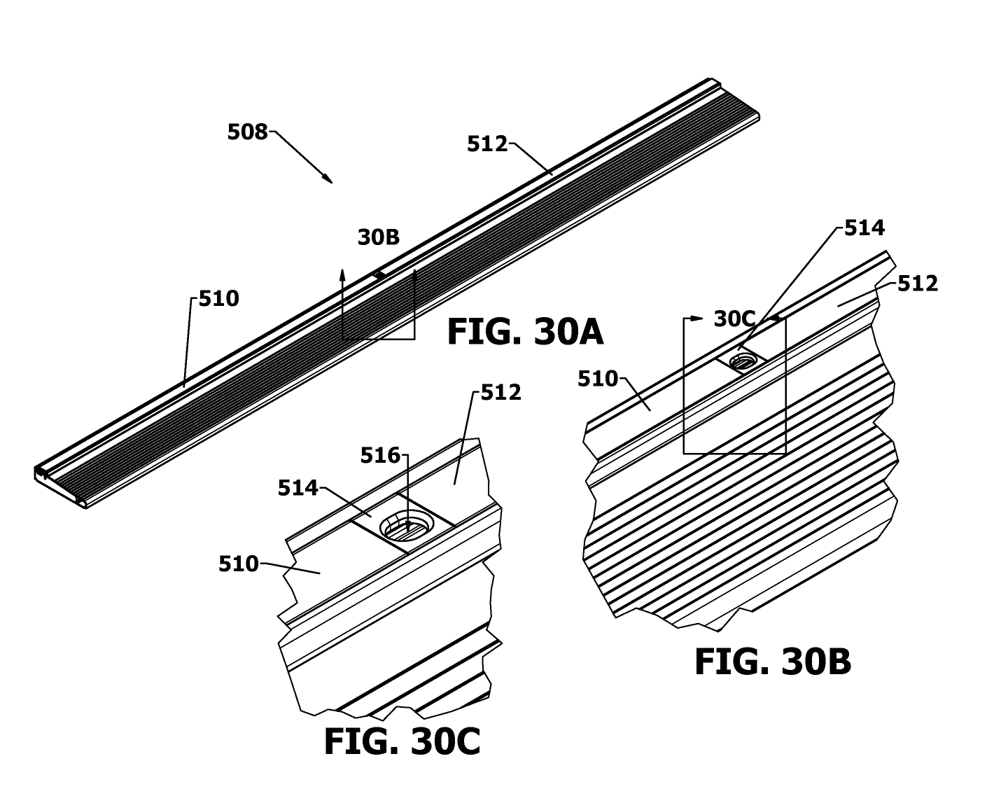

Referring to FIGS. 29A-29C, a French door unit 500 is shown having an active panel 502 and an inactive panel 504 that is locked in place using an astragal 506 that is received in the door sill 508. The door sill 508 may be designed similar to any of the door sills illustrated herein such as the door sills illustrated in FIGS. 1-16. Referring to FIGS. 30A-30C, the door sill for the French door unit 500 typically uses a door sill having a length of about 72 inches and requires a bolt hole for the shoot bolt of the astragal in order to lock the inactive panel in the closed position. Door sill 508 is shown having two threshold caps 510 and 512 and a shoot bolt sleeve 514 positioned there between. In various embodiments, the door sill may be formed by inserting two three foot substrates into a 72 inch extruded aluminum deck. The substrates may be retained in place by lancing the decking into the substrate and/or by clinching the barb 32 (FIG. 2) into the substrate. The punching and clinching operation may be performed using a punch during manufacturing of the door sill.

The shoot bolt sleeve 514 contains a through hole 516 that is positioned intermediate the first shoot bolt guide 38 (FIG. 2) and the second shoot bolt guide 40 (FIG. 2). The through hole 516 is sized and shaped in order to receive the shoot bolt of the astragal 506 (FIG. 29C).

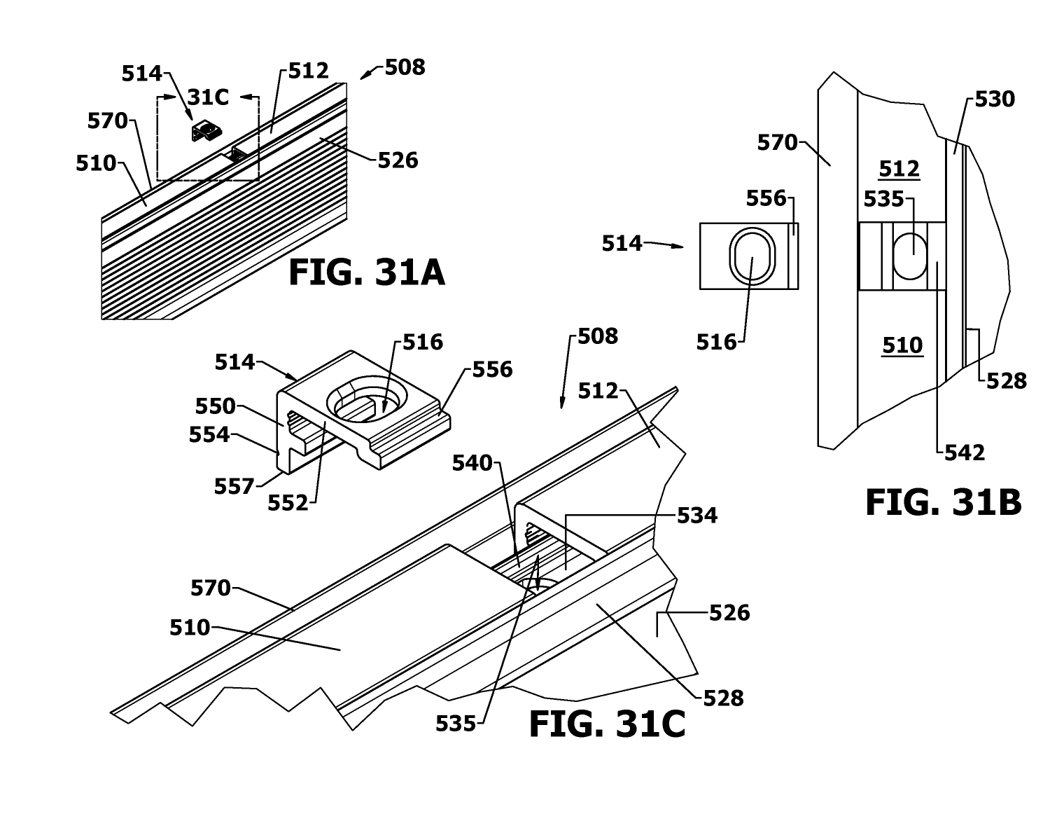

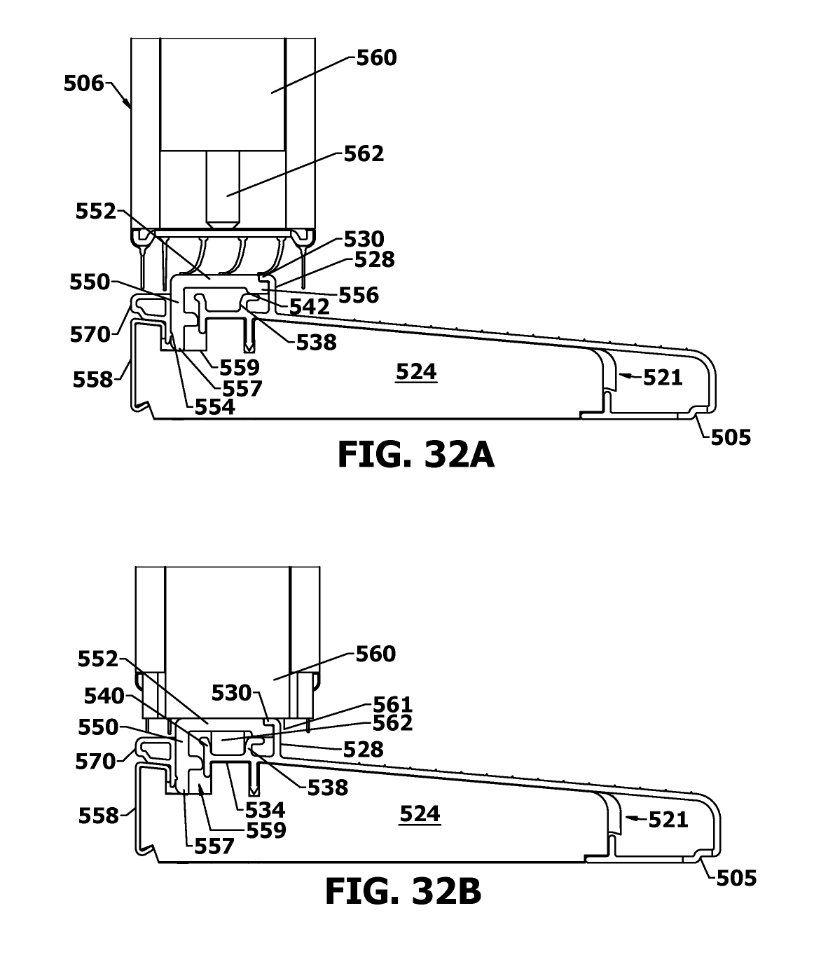

Referring to FIGS. 31A-31C, the shoot bolt sleeve 514 is shown removed from the deck 526 of the door sill 508. Referring particularly to FIG. 31C, the shoot bolt sleeve 514 is shown having a first vertical leg 550 and a second horizontal leg 552. The first vertical leg 550 contains a recess 554 formed proximate a free end of the first vertical leg 550. The second horizontal leg 552 terminates in a recessed lip 556. Referring to FIG. 32A, the recessed lip 556 is configured to fit between the inside protruding lip 530 and the flat 542 on the first shoot bolt guide 538. The end 557 of the vertical leg 550 is sized so that it rests in a recessed channel 559 of a substrate 524. In various embodiments, the end of the recessed lip 556 may contain a flexible, semi flexible or rigid sealing member 49 (FIGS. 3-10) that forms a seal/pressure transition point between the L-shaped shoot bolt guide 514 and the upward extending vertical dam 528.

Still referring to FIGS. 32A-32B, a sectional view of the door sill and astragal 506 is shown with the shoot bolt block 560 and the shoot bolt 562 in an upward non-engaged position. In various embodiments, the substrate 524 may be the substrate shown in FIGS. 19-23, or any other suitable substrate may be used with the deck 526. In the embodiment of FIG. 32A, the air pressure outside the door is equalized with the air pressure located in the channel recess 559 since air can, move through the opening 505 in the deck and up the drain channel 521 formed in the substrate 524. Thus, the seal/pressure transition point for the door sill is located at the back of the channel 559 where the lock key 570 is press-fitted between the C-shaped cap 558 and the first vertical leg 550 of the shoot bolt sleeve 514, similar to that described above with reference to the threshold cap 48 of FIG. 2. One advantage of moving the main seal/pressure transition point of the sill to the back of the channel 559 and above the channel floor is that any water that collects in the channel will not reach the main seal/pressure transition point since the water can drain from the channel 559 via the drain channel 521 to the front of the substrate 524. Additionally, because the air pressure in the channel is equalized through the deck hole 505, the presence of the shoot bolt through hole 516 (FIG. 31C) in the shoot bolt sleeve 514 will not cause water to be sucked through the through hole 516 and into the channel 559 because the air pressure outside the door and in the sill channel 559 is equalized.

Referring particular to FIG. 32B, the shoot bolt block 560 is shown in the lowered position where the shoot bolt 562 passes through the hole 516 in the shoot bolt sleeve 514 (FIG. 31C) and is positioned intermediate the first shoot bolt guide 538 and the second shoot bolt guide 540. In various embodiments, a second through hole 535 (FIG. 31C) is formed through the bottom surface 534 of the extruded aluminum deck 526 so that the shoot bolt is able to pass through the bottom surface 534 and into the substrate 524. Moreover, in the lowered position, a bottom 561 of the shoot bolt block 560 may rest on the top of the second horizontal leg 552 shoot bolt sleeve 514 and the rearward protruding lip 530 of the dam 528.

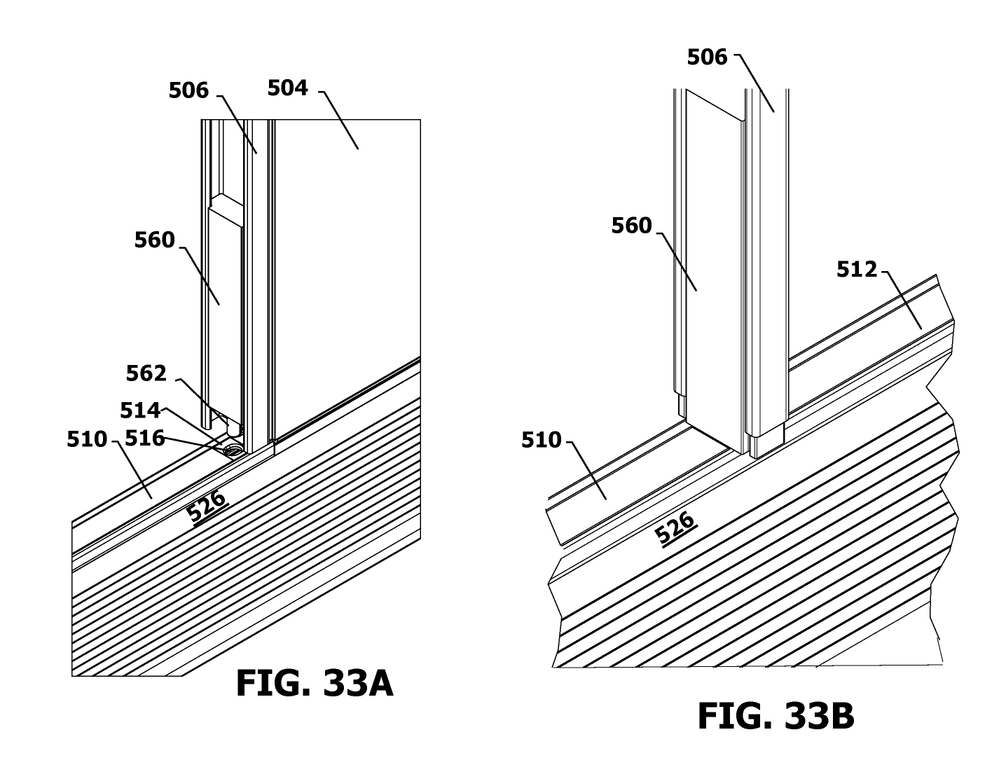

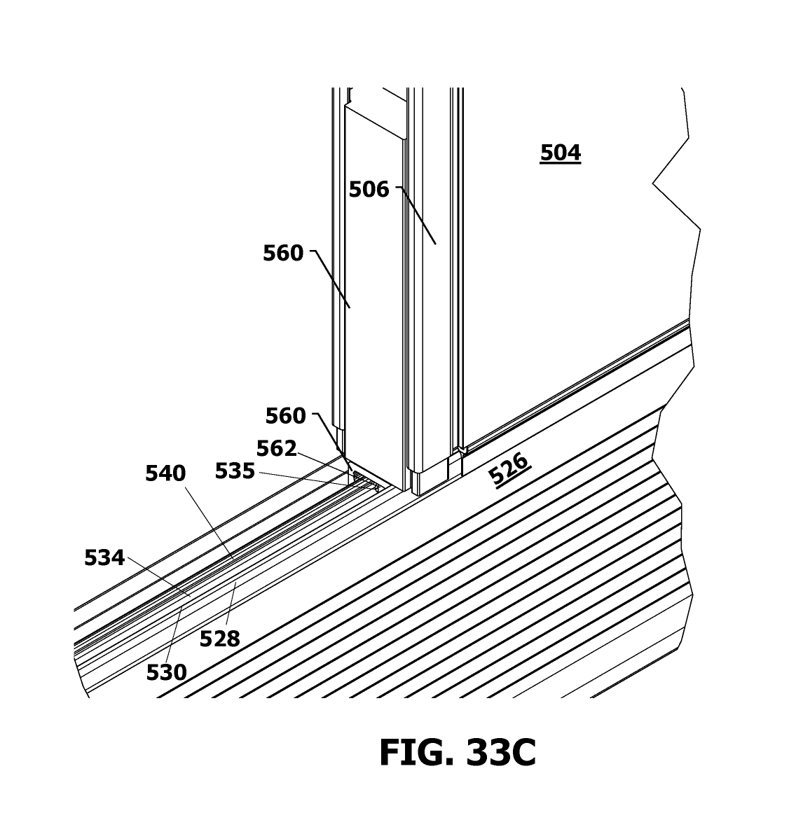

Referring to FIG. 33A, a partial perspective view of the inactive panel 504, the astragal 506, the shoot bolt block 560 and the shoot bolt 562 is shown in the upward disengaged position where the shoot bolt 562 is aligned over the through hole 516 in the shoot bolt sleeve 514. FIG. 33B shows the same parts shown in FIG. 33A but the shoot bolt block 560 and the shoot bolt 562 are in the second engaged position where the shoot bolt 562 is received by the through hole 516 of the shoot bolt sleeve 514. Referring to FIG. 33C, the threshold cap 510 (FIG. 30B) is removed to allow the shoot bolt 562 to be viewed when in the locked position. In this figure, the shoot bolt block 560 is in a lower engaged position where the shoot bolt 562 passes through the through hole 516 (FIG. 33A) of the shoot bolt sleeve 514 intermediate the first shoot bolt guide 530 and the second shoot bolt guide 540. The shoot bolt 562 also passes through the through hole 535 formed through the bottom surface 534 of the extruded aluminum decking 526 intermediate the first shoot bolt guide 530 and the second shoot bolt guide 540.

### Alternate Embodiments of Improved Prior Art Door Bottoms

Endura Articulating Threshold Door Bottom

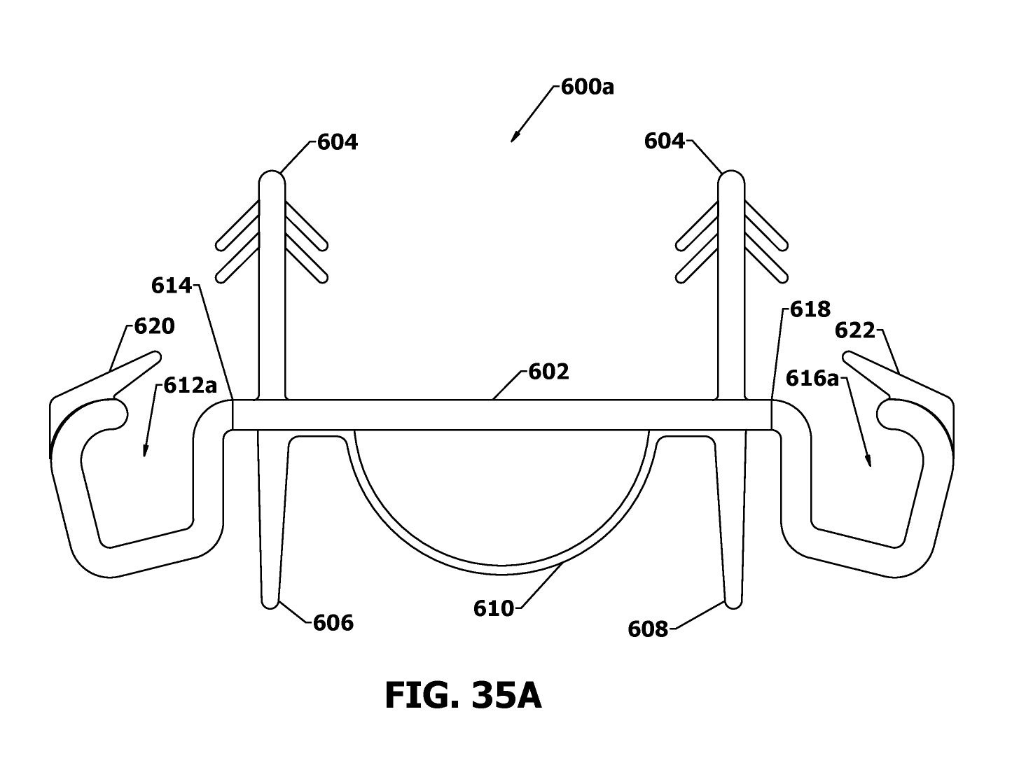

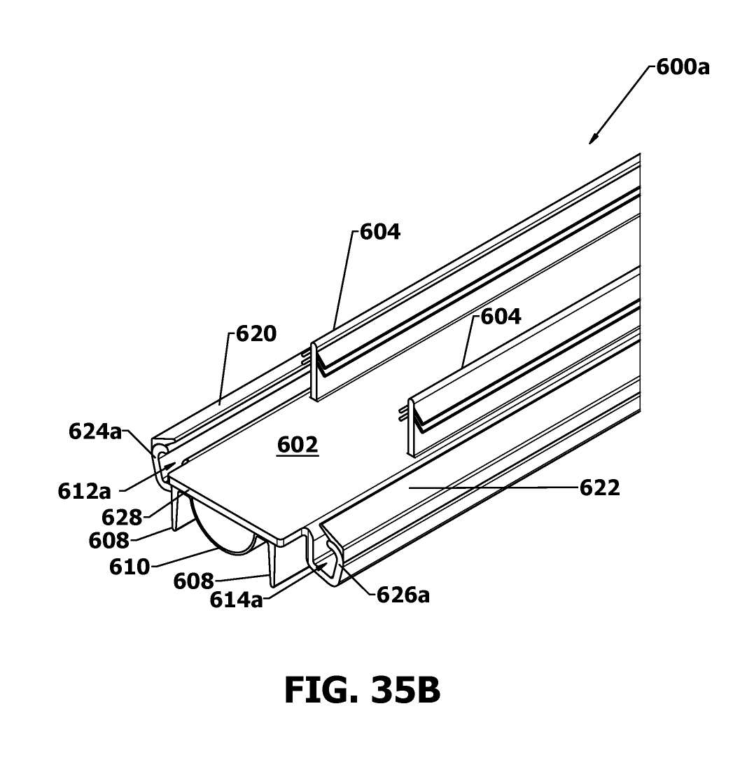

FIGS. 34A-35B illustrate alternate embodiments of Endura's articulating door bottom modified to include the improvements described in FIGS. 17A-18. In particular, a kerf applied door bottom 600 is illustrated comprising a substantially flat carrier 602, one or more upward extending barbs 604 that are configured to be received in one or more kerfs formed in the bottom edge of a door, one or more sealing fins 606 and 608, and one or more sealing bulbs 610. A first upward extending channel 616 is formed at a first side 618 of the substantially flat carrier 602 and a second upward extending channel 612 is formed at a second side 614 of the substantially flat carrier 602. Each upward extending channel may contain a respective drip flow guide 622 and 620, which may also act as a sealing fin against the bottom of the door. In this embodiment, at least one of the upward extending channels 616 or 612 is configured to engage with an articulating threshold sill cap. However, it should be understood that in various embodiments, a separate portion of the door bottom may be configured to engage with the articulating threshold sill cap. Similar to the embodiment of the door bottom shown in FIGS. 17A-18, the first and second upward extending channels 616 and 612 may be shorter in length than the length of the substantially flat carrier 602 such that the respective ends of the channels 626 and 624 are offset from an end 628 (FIG. 34B) of the substantially flat carrier 602. In various embodiments, this may be accomplished by cutting the channel at an angle, forming a notch at the end of the channel or by making the length of the channel to be smaller than a length of the carrier.

Referring in particular to FIGS. 35A-35B, a second embodiment of the Endura's articulating door bottom is illustrated where like parts to the embodiment shown in FIGS. 34A-34B are labeled with like numbers and parts that are different are labeled to include an “a” after the number. As can be seen from the figures, the first and second upward extending channels 616a and 612a are modified such that the walls of the channel extending beyond the plane of the inside surface of the door and the plane of the outside surface of the door.

HVC 4000 Door Bottom

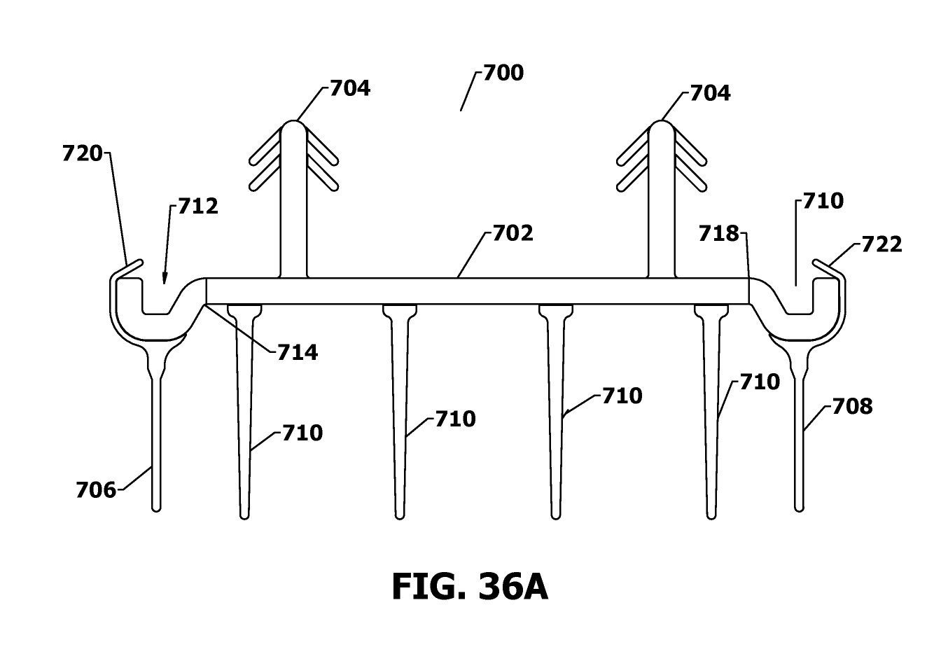

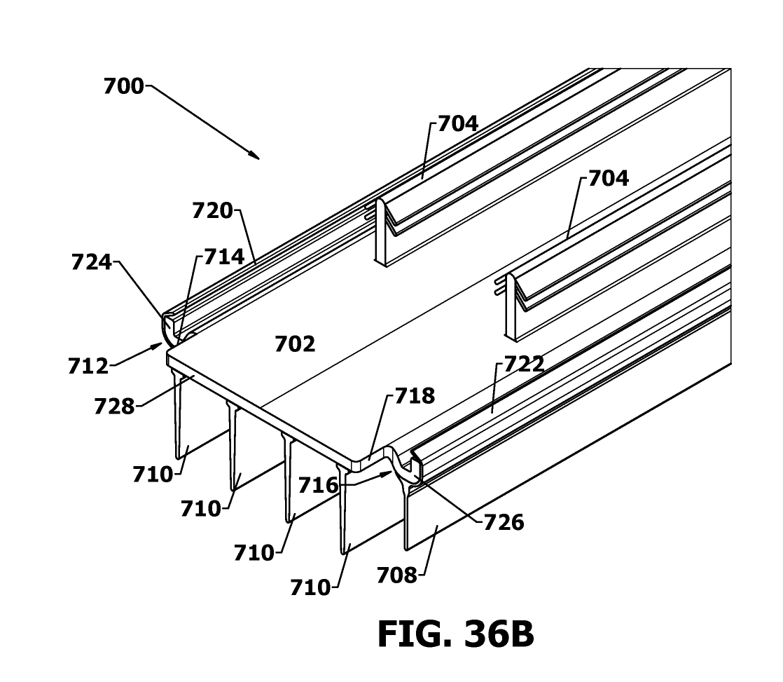

FIGS. 36A-36B illustrate an alternate embodiment of an HVC 4000 door bottom modified to include the improvements described in FIGS. 17A-18. In particular, a kerf applied door bottom 700 is illustrated comprising a substantially flat carrier 702, one or more upward extending barbs 704 that are configured to be received in one or more kerfs formed in the bottom edge of a door, and one or more sealing fins 708 and 710. A first upward extending channel 722 is formed at a first side 718 of the substantially flat carrier 702 and a second upward extending channel 712 is formed at a second side 714 of the substantially flat carrier 702. Each upward extending channel may contain a respective drip flow guide 722 and 720, which may also act as a sealing fin against the bottom of the door. Similar to the embodiment of the door bottom shown in FIGS. 17A-18, the first and second upward extending channels 716 and 712 may be shorter in length than the length of the substantially flat carrier 702 such that the respective ends of the channels 726 and 724 are offset from an end 728 (FIG. 36B) of the substantially flat carrier 702. In various embodiments, this may be accomplished by cutting the channel at an angle, forming a notch at the end of the channel or by making the length of the channel to be smaller than a length of the carrier.

ThermaTru Door Bottom

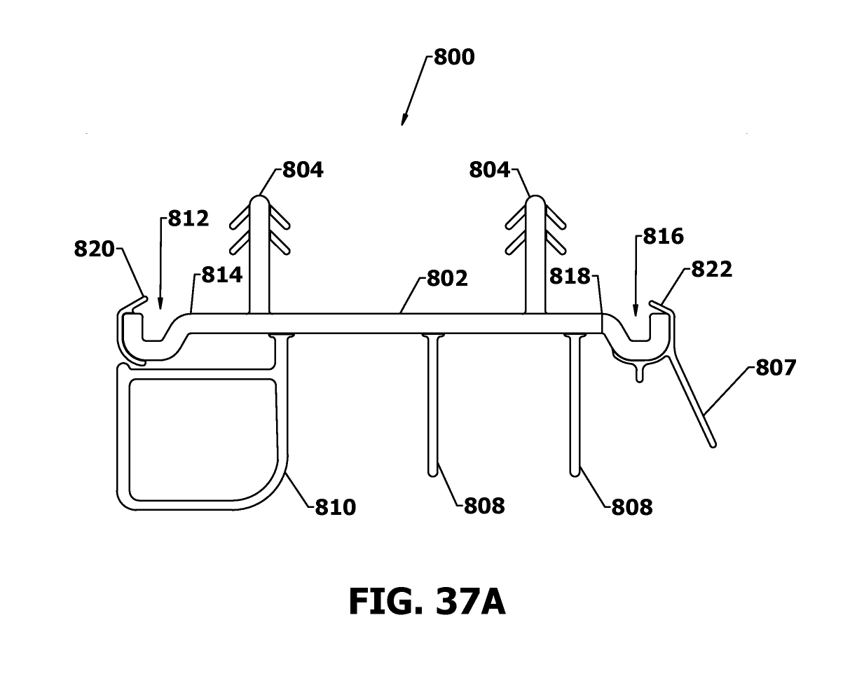

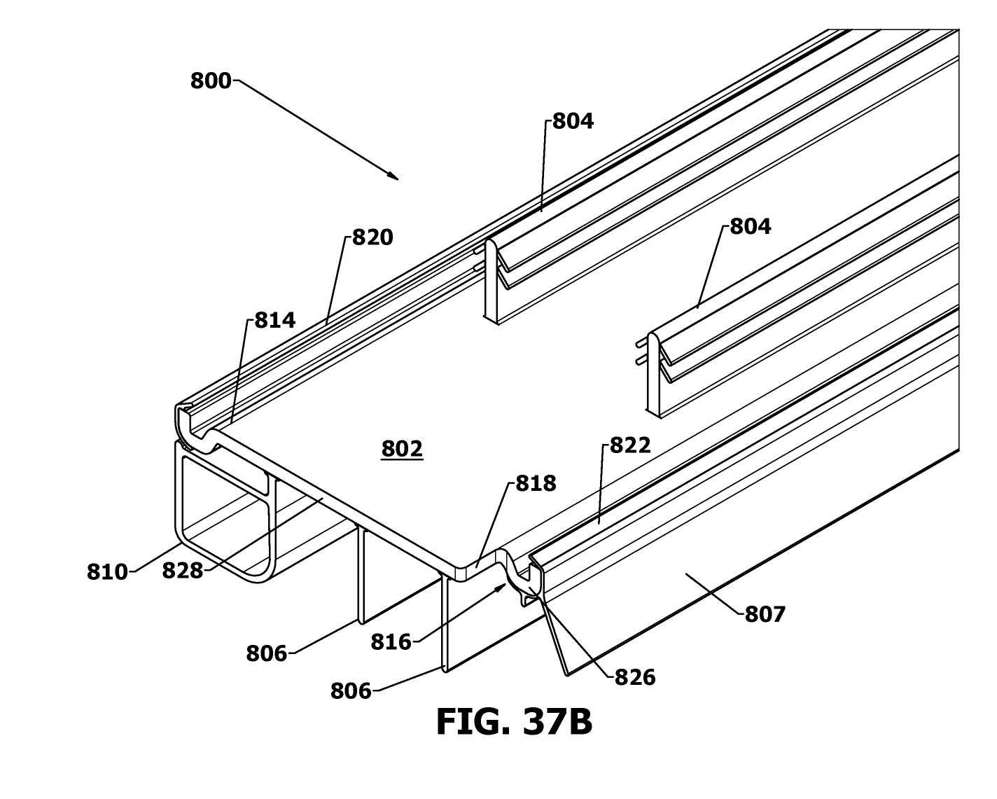

FIGS. 37A-37B illustrate an alternate embodiment of a ThermaTru door bottom modified to include the improvements described in FIGS. 17A-18. In particular, a kerf applied door bottom 800 is illustrated comprising a substantially flat carrier 802, one or more upward extending barbs 804 that are configured to be received in one or more kerfs formed in the bottom edge of a door, and one or more sealing fins 807 and 808. A first upward extending channel 816 is formed at a first side 818 of the substantially flat carrier 802 and a second upward extending channel 812 is formed at a second side 814 of the substantially flat carrier 802. Each upward extending channel may contain a respective drip flow guide 822 and 820, which may also act as a sealing fin against the bottom of the door. Similar to the embodiment of the door bottom shown in FIGS. 17A-18, the first and second upward extending channels 816 and 812 may be shorter in length than the length of the substantially flat carrier 802 such that the respective ends of the channels 826 and 824 are offset from an end 828 (FIG. 36B) of the substantially flat carrier 802. In various embodiments, this may be accomplished by cutting the channel at an angle, forming a notch at the end of the channel or by making the length of the channel to be smaller than a length of the carrier.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations as confirmed by the various embodiments disclosed herein. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

What is claimed:

1. A door sill comprising:
a. a substrate having a recess formed therein;
b. an extruded aluminum deck comprising:
i. at least one upward extending dam that comprises an inside protruding lip;
ii. a first shoot bolt guide; and
iii. a second shoot bolt guide spaced apart from the first shoot bolt guide;
c. a rigid threshold cap comprising:
i. an outside edge configured to be received intermediate the at least one upward dam and the first shoot bolt guide; and
ii. an inside edge configured to be received in the recess formed in the substrate;
d. an interior face cap having a first edge that is at least partially received in the recess formed in the substrate; and
e. a lock key,
wherein:
the extruded aluminum deck at least partially covers a portion of the substrate;
the interior face cap is received on the substrate such that the first end is at least partially received in the recess formed in the substrate, and
the lock key is received intermediate the interior face cap first end and the rigid threshold cap second end to thereby lock the rigid threshold cap and the interior face cap in place.

2. The door sill of claim 1, wherein:
a. the first shoot bolt guide further comprises a flat extending toward the upward extending dam; and
b. the upward extending dam further comprises a lip extending toward the first shoot bolt guide.

3. The door sill of claim 2, wherein the rigid threshold cap first end is received intermediate the shoot bolt guide flat and the upward extending dam lip.

4. The door sill of claim 1, wherein:
a. one of the rigid threshold cap and the lock key comprises a raised ridge and the other of the rigid threshold cap and the lock key comprises a recess formed therein;
b. when the lock key is pressed intermediate the rigid threshold cap second end and the interior face cap, the ridge is received in the recess thereby locking the rigid threshold cap in place.

5. The door sill of claim 1, wherein the rigid threshold cap and the lock key are formed from a polymer.

6. The door sill of claim 1, wherein:
a. the recess formed in the substrate comprises an outside wall, an inside wall, and a bottom surface that extends between the outside wall and the inside wall; and
b. a seal is formed between the inside edge of the rigid threshold cap and the interior face cap proximate the inside wall and above the bottom surface of the recess.

7. The door sill of claim 1, further comprising a shoot bolt sleeve comprising:
a. a first edge configured to be receive intermediate the at least one upward dam and the first shoot bolt guide;
b. a second edge configured to be received in the recess formed in the substrate;
c. a through hole formed through the shoot bolt sleeve,
wherein the through hole is configured to receive a shoot bolt such that the shoot bolt is positioned intermediate the first shoot bolt guide and the second shoot bolt guide.

8. A door bottom comprising:
a. a substantially flat carrier body that is configured to attach to the bottom face of a bottom door rail; and
b. an upwardly open channel formed along the outside edge of the substantially flat carrier body, the channel comprising:
i. a first channel appending wall that has a first edge coupled to the substantially flat carrier body outside edge;
ii. a channel bottom coupled to a second end of the channel appending wall; and
iii. an upward extending second channel wall that is coupled to the channel bottom at a first end of the upward extending second channel wall,
wherein the length of the upwardly open channel is less than the length of the substantially flat carrier body.

9. The door bottom of claim 8, wherein when the door bottom is coupled to the bottom edge of the bottom door rail:
a. a second end of the upwardly extending second channel wall is positioned proximate an outside edge of the bottom edge of the bottom door rail, and
b. the air pressure in the upwardly open channel is substantially equal to the air pressure on the outside face of the door when the door is installed in a structure.

10. The door bottom of claim 8, further comprising a sealing fin coupled to the upwardly extending second channel wall second end, so that the sealing fin forms a seal between the upwardly extending second channel wall second end and the outside edge of the bottom face of the bottom door rail.

11. The door bottom of claim 8, wherein when a door panel to which the door bottom is attached is in a closed position, the ends of the upwardly open channel are not sealed so as to allow the air pressure in the upwardly open channel to equalize with the air pressure outside the door.

12. The door bottom of claim 8, wherein at least one of the first channel appending wall, the channel bottom or the upward extending second channel wall is configured to engage with an articulating threshold sill cap of a door sill positioned beneath the door bottom.

13. The door bottom of claim 8, further comprising one or more sealing fins and/or bulbs extending downward from a bottom surface of the substantially slat carrier body.

14. A door bottom comprising:
a. a carrier body that is configured to attach to a bottom face of a bottom door rail; and
b. at least one upwardly open channel formed along one of the outside edge or the inside edge of the carrier body so that when the carrier body is attached to the bottom edge of the bottom door rail, the upwardly open channel is positioned proximate one of an inside edge or an outside edge of the bottom face of the bottom door rail to which the carrier body is attached.

15. The door bottom of claim 14, wherein a length of the at least one upwardly open channel proximate the outside edge of the bottom rail face is shorter than a length of the carrier body so that a first end of the at least one upwardly open channel is recessed away from a first end of the carrier body and a second end of the at least one upwardly open channel is recessed away from a second end of the carrier body.

16. The door bottom of claim 14, wherein the at least one upwardly open channel further comprises:
a. a downward extending channel wall that has a first edge coupled to the substantially flat carrier body;
b. a channel bottom coupled to a second edge of the downward extending channel wall; and
c. an upward extending channel wall that has a first edge that is coupled to the channel bottom,
wherein a second edge of the upward extending channel wall is adjacent to the bottom edge of the bottom door rail intermediate the inside edge and the outside edge of the bottom edge of the bottom door rail when the carrier is attached to the bottom door rail.

17. The door bottom of claim 16, further comprising a sealing fin coupled to the upward extending channel wall so that the sealing fin abuts a portion of the bottom door rail.

18. A door sill substrate comprising:
a. an elongated body comprising:
i. a top surface;
ii. a bottom surface;
iii. a first end;
iv. a second end;
v. an inside edge extending between the first end and the second end; and
vi. an outside edge extending between the first end and the second end;
b. a first upward open channel formed through the elongated body top surface, the first upward open channel comprising a bottom surface having a first portion and a second portion; and
c. a drainage channel having a first end that is positioned intermediate the bottom surface first portion and the bottom surface second portion, and a second end that opens to the outside edge of the elongated body;
wherein, the first portion of the bottom surface is sloped downward from the first end toward the drainage channel.

19. The door sill substrate of claim 18, further comprising a second upward open channel formed intermediate the first upward open channel and the outside edge, wherein the second upward open channel is configured to receive a portion of a sill deck that covers at least a portion of the door sill substrate.

20. The door sill substrate of claim 18, further comprising a plurality of elongated grooves formed in the bottom surface and that are parallel to the first end and the second end.

21. The door sill substrate of claim 18, wherein the elongated body is formed from a material selected from a group consisting of:
a. an injection molded polymer;
b. an injection molded foam polymer;
c. wood;
d. a composite material; and
e. an molded insulating material.

22. A door sill substrate comprising:
a. an elongated body comprising:
i. a top surface;
ii. a bottom surface;
iii. a first end;
iv. a second end;
v. an inside edge extending between the first end and the second end; and
vi. an outside edge extending between the first end and the second end; and
b. a plurality of groves formed on the bottom surface,
wherein the plurality of grooves facilitate the spreading of caulking across the bottom surface so that the elongated body does not bow when installed.

23. The door sill substrate of claim 22, further comprising a first upward open channel formed through the elongated body top surface, the first upward open channel comprising a bottom surface that has:
a. a first portion that slopes downward from the first end of the elongated body toward the second end of the elongated body; and
b. a second portion that extends from the first portion toward the second end of the elongated body and that is substantially parallel to the top surface of the elongated body.

24. The door sill substrate of claim 23, further comprising a drainage channel having a first end that is positioned intermediate the bottom surface first and second portions and a second end that opens to the outside edge of the elongated body.

25. A door sill system comprising:
a. a substrate having an upward open channel formed therein;
b. an extruded aluminum deck that at least partially covers the substrate;
c. at least one threshold cap; and
d. an interior face cap that covers a portion of the substrate;
wherein
a first portion of the at least one threshold cap is coupled to the extruded aluminum deck;
a second portion of the at least one threshold cap is positioned in the recessed upward open channel adjacent a portion of the interior face cap; and
a seal is formed between the second portion of the at least one threshold cap and the interior face cap above a bottom surface of the upward open channel.

26. The door sill system of claim 25, further comprising a lock key that is at least partially received intermediate the second portion of the at least one threshold cap and the portion of the interior face cap to form the seal.

27. The door sill system of claim 25, wherein the seal is positioned along the inside wall of the upward open channel above the bottom surface of the upward open channel.

28. The door sill system of claim 25, further comprising:
a. a second threshold cap, wherein the at least one threshold cap and the second threshold cap each comprise a first end and an opposite second end; and
b. a shoot bolt sleeve that is received intermediate the second end of the at least one threshold cap and the first end of the second threshold cap.

29. The door sill system of claim 28, wherein
a. the extruded aluminum deck further comprises:
i. at least one upward extending dam that comprises an inside protruding lip;
ii. a first shoot bold guide; and
iii. a second shoot bolt guide spaced apart from the first shoot bolt guide;
b. the at least one threshold cap comprises:
i. a first edge configured to be receive intermediate the at least one upward dam and the first shoot bolt guide; and
ii. a second edge configured to be received in the recess formed in the substrate;
c. the second threshold cap comprises:
i. a first edge configured to be receive intermediate the at least one upward dam and the first shoot bolt guide; and
ii. a second edge configured to be received in the recess formed in the substrate;
d. the shoot bolt sleeve comprises:
i. a first edge configured to be receive intermediate the at least one upward dam and the first shoot bolt guide; and
ii. a second edge configured to be received in the recess formed in the substrate.

30. The door sill system of claim 25, further comprising a door bottom comprising:
a. a carrier body that is configured to attach to a bottom face of a bottom door rail; and
b. at least one upwardly open channel formed along one of the outside edge or the inside edge of the carrier body so that when the carrier body is attached to the bottom edge of the bottom door rail, the upwardly open channel is positioned proximate one of an inside edge or an outside edge of the bottom edge of the bottom door rail to which the carrier body is attached.

31. The door sill system of claim 30, wherein a length of the at least one upwardly open channel is shorter than a length of the carrier body so that a first end of the at least one upwardly open channel is recessed away from a first end of the carrier body and a second end of the at least one upwardly open channel is recessed away from a second end of the carrier body.

32. The door sill system of claim 30, wherein the at least one upwardly open channel further comprises:
a. a downward extending channel wall that has a first edge coupled to the substantially flat carrier body;
b. a channel bottom coupled to a second edge of the downward extending channel wall; and
c. an upward extending channel wall that has a first edge that is coupled to the channel bottom,
wherein a second edge of the upward extending channel wall is adjacent to the bottom edge of the bottom door rail intermediate the inside edge and the outside edge of the bottom edge of the bottom door rail when the carrier is attached to the bottom door rail.

33. The door sill system of claim 32, further comprising a sealing fin coupled to the upward extending channel wall so that the sealing fin abuts a portion of the bottom door rail.

34. A door sill system comprising:
a. a substrate;
b. an extruded aluminum deck that at least partially covers the substrate, the extruded aluminum decking having:
i. an outside upwardly extending first arm; and
ii. an inside upwardly extending second arm spaced apart from the outside upwardly extending first arm;
c. at least one threshold cap comprising:
i. a horizontal body having an inside edge, an outside edge and one or more holes formed through the horizontal body;
ii. a first downwardly extending arm having a first end that is coupled to the horizontal body outside edge, wherein a second end of the first downwardly extending arm has an inside extending flange; and
iii. a second downwardly extending arm having a first end that is coupled to the horizontal body inside edge, wherein a second end of the second downwardly extending arm has an outside extending flange; and
iv. at least one adjustment mechanism that is received intermediate the inside extending flange and the outward extending flange such that a portion of the adjustment mechanism aligns with one of the one or more holes;
wherein
the at least one threshold cap is slidably retained intermediate the outside upwardly extending first arm and the inside upwardly extending second arm;
when a first portion of the adjustment mechanism is rotated with respect to a second portion of the adjustment mechanism that is rotationally fixed intermediate the inside extending flange and the outward extending flange, the at least one threshold cap is moveable between:
a first position in which a top surface of the horizontal body of the threshold cap is substantially aligned with a top surface of each of the outside upwardly extending first arm and the inside upwardly extending second arm; and
a second position in which the top surface of the horizontal body of the threshold cap is not substantially aligned with the top surface of each of the outside upwardly extending first arm and the inside upwardly extending second arm.

35. The door sill system of claim 34, wherein
a. the first portion of the adjustment mechanism further comprises a nut that is rotationally fixed intermediate the inside extending flange and the outward extending flange; and
b. the second portion of the adjustment mechanism further comprises a threaded shaft that is rotatably received in the nut.

36. The door sill system of claim 34, further comprising:
a. an interior face cap coupled to the aluminum deck; and
b. a key lock positioned intermediate the interior face cap and the at least one threshold cap,
wherein a seal is formed between the inside upwardly extending second arm and the threshold cap.
